(19) United States
(12) Patent Application Publication
(10) Pub. No.: US 2015/0186883 A1
(43) Pub. Date: Jul. 2, 2015

(54) Electronic Account Data Transfer Method And Related Device And System

(71) Applicant: Tencent Technology (Shenzhen) Company Limited, Shenzhen (CN)

(72) Inventor: Zhigang SONG, Shenzhen (CN)

(21) Appl. No.: 14/569,410

(22) Filed: Dec. 12, 2014

Related U.S. Application Data
(63) Continuation of application No. PCT/CN2014/080796, filed on Jun. 26, 2014.

(30) Foreign Application Priority Data
Dec. 31, 2013 (CN) 201310750757.8

(51) Int. Cl. G06Q 20/40; G06Q 20/10

(52) U.S. Cl. CPC G06Q 20/401; G06Q 20/10

(57) ABSTRACT

A server system is provided that performs a secure payment transfer method. The server receives a request from a first client device for transfer verification information corresponding to a proposed funds transfer, the request including a proposed amount of funds to be transferred. The server sends the transfer verification information to the first client device and receives, from a second client device, the transfer verification information. The server system determines a usage state of the transfer verification information. If the usage state is an unused state, the server transfers an amount of funds from an account of the user of the first client device to an account of a user of the second client device. If the usage state is a used state, the server refuses the transfer from the account of the user of the first client device to the account of the user of the second client device.

### RELATED APPLICATIONS

This application is a continuation application of PCT Patent Application No. PCT/CN2014/080796, entitled “ELECTRONIC ACCOUNT DATA TRANSFER METHOD AND RELATED DEVICE AND SYSTEM” filed on Jun. 26, 2014, which claims priority to Chinese Patent Application No. 201310750757.8, entitled “ELECTRONIC ACCOUNT DATA TRANSFER METHOD AND RELATED DEVICE AND SYSTEM” filed Dec. 31, 2013, both of which are herein incorporated by reference in their entirety.

### FIELD OF THE DISCLOSURE

The present embodiments relate generally to methods of secure payment over the Internet (or another network) and server systems that perform said methods.

### BACKGROUND

Near field communication (NFC) is used in a variety of offline payment methods. Typically, a server will store and manage account funds, and a consumer will make use of a physical chip (e.g., on a smart phone) that is NFC-enabled to deduct and/or transfer funds, even while he or she is “offline.” While convenient for consumers, who need not be connected to the Internet to make a payment, these NFC payment methods are prone to security concerns.

### SUMMARY

To address the aforementioned problems, a method is provided for secure payments over the Internet (or another network). In particular, the method provides a manner in which a consumer can safely pay a vendor while the consumer is optionally in an “offline” state. The method is performed at a server system comprising one or more processors and memory and includes receiving a request from a first client device for transfer verification information corresponding to a proposed funds transfer. The received request includes a proposed amount of funds to be transferred in the proposed funds transfer. The server system sends the transfer verification information to the first client device and receives, from a second client device, the transfer verification information. Upon a determination that the usage state of the transfer verification information is an unused state, the server system transfers an amount of funds from an account of the user of the first client device to an account of a user of the second client device. Upon a determination that the usage state of the transfer verification information is a used state, the server system refuses transfer of the amount of funds from the account of the user of the first client device to the account of a user of the second client device.

In another aspect of the present disclosure, a server system is provided for handling secure payments over the Internet (or another network). In particular, the server system receives a request from a first client device for transfer verification information corresponding to a proposed funds transfer. The received request includes a proposed amount of funds to be transferred in the proposed funds transfer. The server system sends the transfer verification information to the first client device and receives, from a second client device, the transfer verification information. Upon a determination that the usage state of the transfer verification information is an unused state, the server system transfers an amount of funds from an account of the user of the first client device to an account of a user of the second client device. Upon a determination that the usage state of the transfer verification information is a used state, the server system refuses transfer of the amount of funds from the account of the user of the first client device to the account of a user of the second client device.

In another aspect of the present disclosure, a non-transitory computer readable storage medium is provided for instructing a server system to handle secure payments over the Internet (or another network). To this end, the non-transitory computer readable storage medium includes instructions that cause the server system to receive a request from a first client device for transfer verification information corresponding to a proposed funds transfer. The received request includes a proposed amount of funds to be transferred in the proposed funds transfer. The server system sends the transfer verification information to the first client device and receives, from a second client device, the transfer verification information. Upon a determination that the usage state of the transfer verification information is an unused state, the server system transfers an amount of funds from an account of the user of the first client device to an account of a user of the second client device. Upon a determination that the usage state of the transfer verification information is a used state, the server system refuses transfer of the amount of funds from the account of the user of the first client device to the account of a user of the second client device.

In another aspect of the present disclosure, to address the aforementioned problems, some implementations provide a non-transitory computer readable storage medium storing one or more programs. The one or more programs comprise instructions, which when executed by a server system with one or more processors and memory, cause the server system to perform any of the methods provided herein.

In yet another aspect of the present disclosure, to address the aforementioned problems, some implementations provide a server system. The server system includes one or more processors, memory, and one or more programs. The one or more programs are stored in memory and configured to be executed by the one or more processors. The one or more programs include an operating system and instructions that when executed by the one or more processors cause the server system to perform any of the methods provided herein.

### BRIEF DESCRIPTION OF THE DRAWINGS

The aforementioned features and advantages of the disclosed embodiments as well as additional features and advantages thereof will be more clearly understood hereinafter as a result of a detailed description of preferred embodiments when taken in conjunction with the drawings.

FIG. 1A is a schematic flowchart of an electronic account data transfer method, in accordance with some embodiments.

FIG. 1B is a schematic flowchart of another electronic account data transfer method, in accordance with some embodiments.

FIG. 2 is a schematic flowchart of another electronic account data transfer method, in accordance with some embodiments.

FIG. 3 is a schematic flowchart of another electronic account data transfer method, in accordance with some embodiments.

FIG. 4 is a schematic flowchart of another electronic account data transfer method, in accordance with some embodiments.

FIG. 5 is a schematic flowchart of another electronic account data transfer method, in accordance with some embodiments.

FIG. 6 is a schematic flowchart of another electronic account data transfer method, in accordance with some embodiments.

FIG. 7 is a schematic structural diagram of a client device, in accordance with some embodiments.

FIG. 8 is a schematic structural diagram of another client device, in accordance with some embodiments.

FIG. 9 is a schematic structural diagram of another client device, in accordance with some embodiments.

FIG. 10 is a schematic structural diagram of another client device, in accordance with some embodiments.

FIG. 11 is a schematic structural diagram of a server, in accordance with some embodiments.

FIG. 12 is a schematic structural diagram of another server, in accordance with some embodiments.

FIG. 13 is a schematic structural diagram of an electronic account data transfer system, in accordance with some embodiments.

FIGS. 14A-14B are a flowchart illustrating a method of handling a secure payment over a network, in accordance with some embodiments.

FIG. 15 is a server-client environment that includes a network over which secure payments are made, in accordance with some embodiments.

FIG. 16 is a structural block diagram of a client, in accordance with some embodiments.

FIG. 17 is a structural block diagram of a server, in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

Embodiments of the present disclosure provide an electronic account data transfer method, and a related device and system, which can effectively improve account security, and are described in the following respectively.

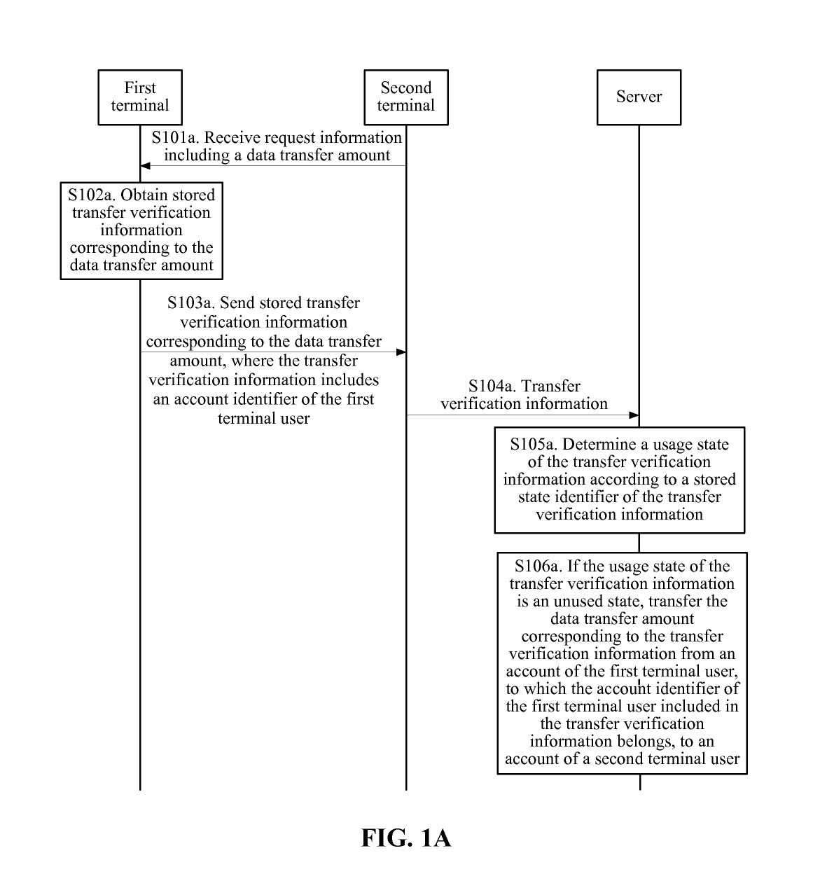

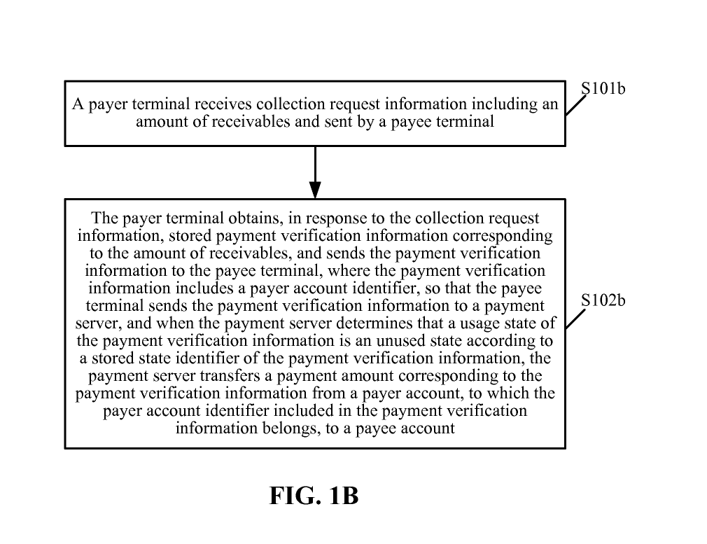

Referring to FIG. 1A, FIG. 1A is a schematic flowchart of an electronic account data transfer method disclosed by an embodiment of the present embodiment. The electronic account data transfer method described in FIG. 1A is mainly described from the side of a first client device, the side of a second client device, and the side of a server. As shown in FIG. 1A, the electronic account data transfer method may include the following steps.

S101A: A first client device receives request information including a data transfer amount and sent by a second client device.

In some embodiments, the first client device and the second client device may include client devices such as a smart phone, a tablet computer, a palmtop computer, and a mobile Internet device (MID), which are not limited in some embodiments.

In some implementations, after receiving the request information including the data transfer amount and sent by the second client device, the first client device may output the request information, and the first client device performs Step S102a after detecting an acknowledgment operation input by a first client device user in response to the request information.

S102a: The first client device obtains, in response to the request information, stored transfer verification information corresponding to the data transfer amount.

In some embodiments, assuming that the data transfer amount included in the request information is 20, the first client device can obtain, in response to the request information, the transfer verification information corresponding to 20. In an embodiment, the transfer verification information may include 20 signatures, where each signature may include an account identifier of the first client device user, a signature serial number, and may further include other necessary information such as a first client device identifier, signature generating timestamp, and so on.

S103a: The first client device sends the stored transfer verification information corresponding to the data transfer amount to a second client device, where the transfer verification information includes an account identifier of the first client device user.

S104a: The second client device receives the transfer verification information sent by the first client device, and sends the transfer verification information to the server.

S105a: The server receives the transfer verification information sent by the second client device, and determines a usage state of the transfer verification information according to a stored state identifier of the transfer verification information.

S106a: If the usage state of the transfer verification information is an unused state, the server transfers the data transfer amount corresponding to the transfer verification information from an account of the first client device user, to which the account identifier of the first client device user included in the transfer verification information belongs, to an account of a second client device user.

In some implementations, in the method described in FIG. 1A, before performing Step S101A, the first client device may further perform the following steps.

Step 11A: The first client device sends a transfer verification information request to the server, where the transfer verification information request includes the account of the first client device user and the data transfer amount, so that the server generates the transfer verification information corresponding to the data transfer amount after verifying that the account of the first client device user included in the transfer verification information request is valid, where the transfer verification information corresponding to the data transfer amount includes the account identifier of the first client device user.

In some embodiments, the first client device may send the transfer verification information request to the server when being triggered by a user, or the first client device may also send the transfer verification information request to the server when a set time arrives.

In some embodiments, the data transfer amount included in the transfer verification information request may also be referred to as an offline data transfer amount, and the data transfer amount included in the transfer verification information request may be greater than or equal to the data transfer amount included in the request information sent by the second client device.

In some embodiments, the transfer verification information request may further include a first client device identifier, such as a phone number of the first client device, an International Mobile Equipment Identity (IMEI), and so on, which is not limited in some embodiments.

Step 12A: The first client device receives the transfer verification information corresponding to the data transfer amount and sent by the server.

In some embodiments, the transfer verification information corresponding to the data transfer amount and sent by the server may include a plurality of signatures. For example, when the data transfer amount included in the transfer verification information request is 100, the first client device may receive transfer verification information including 100 signatures and sent by the server. Each signature may include the account identifier of the first client device user and a signature serial number, and optionally, each signature may further include other necessary information such as a first client device identifier, a signature generating timestamp, and so on.

In some embodiments, the server may use a private key of an asymmetric cryptographic algorithm as a signature, while a public key can be open to the second client device, so that the second client device can verify signatures of the transfer verification information by using the public key.

In some embodiments, the server may use an abstract algorithm (such as SHA-1, DM5, and so on) to generate an abstract for the above information, and use the private key to encrypt the generated abstract content to generate a signature.

Step 13A: The first client device saves the received transfer verification information corresponding to the data transfer amount.

In some embodiments, the transfer verification information includes a plurality of signatures, and therefore, the transfer verification information may also be referred to as a signature string.

In some implementations, in the method described in FIG. 1A, after the first client device sends the stored transfer verification information to the second client device, the first client device may delete the stored transfer verification information.

In the method described in FIG. 1A, a client device commonly used at present can be directly used to transfer data in the account without transforming hardware devices or adding a new physical chip, which can avoid a data loss when technologies such as NFC are used to deduct data from the account stored by the physical chip, thereby effectively improving the account security.

In some embodiments, the electronic account data transfer method disclosed by some embodiments can be applied to a payment scenario. Referring to FIG. 1B, FIG. 1B is a schematic flowchart of an electronic account data transfer method disclosed by an embodiment of the present disclosure. The method described in FIG. 1B is mainly described from the side of a payer client device. The payer client device may include client devices such as a smart phone, a tablet computer, a palmtop computer, and an MID, which are not limited in some embodiments. As shown in FIG. 1B, the method may include the following steps.

S101B: A payer client device receives collection request information including an amount of receivables and sent by a payee client device.

In some embodiments, the payee client device may include client devices such as a smart phone, a tablet computer, a palmtop computer, and an MID, which are not limited in some embodiments.

In this embodiment, the “amount of receivables” in Step S101B is equivalent to the “data transfer amount” described in the foregoing embodiment.

S102B: The payer client device obtains, in response to the collection request information, stored payment verification information corresponding to the amount of receivables, and sends the payment verification information to the payee client device, where the payment verification information includes a payer account identifier, so that the payee client device sends the payment verification information to a payment server, and when the payment server determines that a usage state of the payment verification information is an unused state according to a stored state identifier of the payment verification information, the payment server transfers a payment amount corresponding to the payment verification information from a payer account, to which the payer account identifier included in the payment verification information belongs, to a payee account.

In this embodiment, the “payment verification information” in Step S102B is equivalent to the “transfer verification information” described in the foregoing embodiment.

In some embodiments, the payment verification information sent by the payer client device to the payee client device may include a plurality of signatures corresponding to the amount of receivables, where each signature may include the payer account identifier and a signature serial number, and may further include other necessary information such as a payer client device identifier, a signature generating timestamp, and so on.

In some implementations, in the method described in FIG. 1B, before performing Step S101B, the payer client device may further perform the following steps.

Step 11B: The payer client device sends a payment verification information request to the payment server, where the payment verification information request includes the payer account and the payment amount, so that the payment server generates the payment verification information corresponding to the payment amount after verifying that the payer account included in the payment verification information request is valid, where the payment verification information corresponding to the payment amount includes the payer account identifier.

In some embodiments, the payer client device may send the payment verification information request to the payment server when being triggered by a user, or the payer client device may also send the payment verification information request to the payment server when a set time arrives.

In some embodiments, the payment amount included in the payment verification information request may also be referred to as an offline payment amount, and the payment amount included in the payment verification information request may be greater than or equal to the amount of receivables included in the collection request information sent by the payee client device.

In some embodiments, the payment verification information request may further include a payer client device identifier, such as a phone number of the payer client device, an IMEI, and so on, which is not limited in some embodiments.

Step 12b: The payer client device receives the payment verification information corresponding to the payment amount and sent by the payment server.

In some embodiments, the payment verification information corresponding to the payment amount and sent by the payment server may include a plurality of signatures. For example, when the payment amount included in the payment verification information request is 100, the payer client device may receive payment verification information including 100 signatures and sent by the payment server. Each signature may include the payer account identifier and a signature serial number, and optionally, each signature may further include other necessary information such as a payer client device identifier, a signature generating timestamp, and so on.

In some embodiments, the payment server may use a private key of an asymmetric cryptographic algorithm as a signature, while a public key can be open to the payee client device, so that the payee client device can verify signatures of the payment verification information by using the public key.

In some embodiments, the payment server may use an abstract algorithm (such as SHA-1, DM5, and so on) to generate an abstract for the above information, and use the private key to encrypt the generated abstract content to generate a signature.

Step 13b: The payer client device saves the received payment verification information corresponding to the payment amount.

In some embodiments, the payment verification information includes a plurality of signatures, and therefore, the payment verification information may also be referred to as a signature string.

In some implementations, in the method described in FIG. 1B, after the payer client device sends the stored payment verification information to the payee client device, the payer client device may delete the stored payment verification information.

In the method described in FIG. 1B, a client device commonly used at present can be directly used for implementing payment without transforming hardware devices or adding a new physical chip, which can avoid a loss of account funds when technologies such as NFC are used to deduct account funds stored by the physical chip, thereby effectively improving the account security.

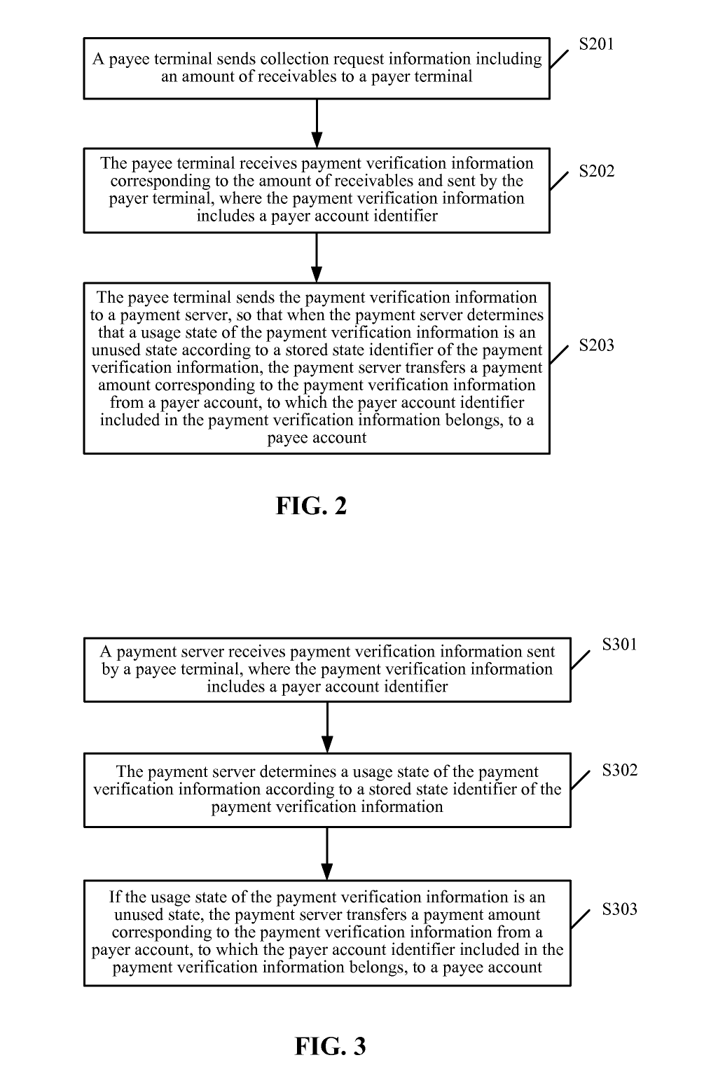

Referring to FIG. 2, FIG. 2 is a schematic flowchart of another electronic account data transfer method disclosed by an embodiment of the present disclosure. The method described in FIG. 2 is mainly described from the side of a payee client device. The payee client device may include client devices such as a smart phone, a tablet computer, a palmtop computer, and an MID, which are not limited in some embodiments. As shown in FIG. 2, the method may include the following steps.

S201: A payee client device sends collection request information including an amount of receivables to a payer client device.

In some embodiments, the payee client device may send the collection request information including the amount of receivables to the payer client device, or the payee client device may also send the collection request information including the amount of receivables to the payer client device when a set time arrives.

S202: The payee client device receives payment verification information corresponding to the amount of receivables and sent by the payer client device, where the payment verification information includes a payer account identifier.

S203: The payee client device sends the payment verification information to a payment server, so that when the payment server determines that a usage state of the payment verification information is an unused state according to a stored state identifier of the payment verification information, the payment server transfers a payment amount corresponding to the payment verification information from a payer account, to which the payer account identifier included in the payment verification information belongs, to a payee account.

In some embodiments, the payee client device may send the payment verification information to the payment server by using request information, where the request information may carry a payee client device identifier, and correspondingly, the payment server may learn a payee account number bound to the payee client device identifier according to the payee client device identifier. In an embodiment, the request information may directly carry the payee account number, which is not limited in some embodiments.

In some implementations, in the method described in FIG. 2, after performing Step S202 and before performing Step S203, the payee client device may further perform the following step:

The payee client device verifies whether the payment verification information is valid, if the payment verification information is verified to be valid, performs step S203, and otherwise, discards the payment verification information.

In some embodiments, the payee client device may verify signatures in the payment verification information one by one by using an open public key (such as an RSA public key) of the payment server, and if each signature is verified to be valid, it indicates that the payment verification information is valid, and the payee client device may perform Step S203.

In some embodiments, when the payee client device verifies that a content format of a signature is the same as a preset content format (for example, including a payer client device identifier, a signature serial number, a signature generating timestamp, and so on), the payee client device determines that the signature is valid; otherwise, the payee client device determines that the signature is invalid.

In some implementations, in the method described in FIG. 2, the step of the payee client device sending the payment verification information to a payment server includes:

the payee client device detecting whether a network connection to the payment server exists, and if the network connection exists, sending the payment verification information to the payment server; on the contrary, if the payee client device detects that no network connection to the payment server exists, the payee client device saving the payment verification information, and after detecting that a network connection to the payment server exists, the payee client device sending the payment verification information to the payment server. In other words, in some embodiments, when being online, the payee client device can directly send the payment verification information to the payment server, and when being offline, the payee client device can store the payment verification information and send the payment verification information to the payment server when the payee client device gets online again.

In some implementations, in the method described in FIG. 2, after the payee client device detects that no network connection to the payment server exists and saves the payment verification information, the payee client device may send first prompt information to the payer client device, where the first prompt information is used for indicating that the payment verification information has been verified and saved by the payee client device, and is waiting for a payment operation, so that the payer can learn a payment execution process in time.

In some implementations, in the method described in FIG. 2, after sending the payment verification information to the payment server, the payee client device may also send second prompt information to the payer client device, where the second prompt information is used for indicating that the payment verification information has been sent to the payment server for a payment operation, so that the payer can learn a payment execution process in time.

In some embodiments, the payment verification information may include a plurality of signatures corresponding to the amount of receivables, where each signature includes a payer account identifier and a signature serial number.

In the method described in FIG. 2, a client device commonly used at present can be directly used for implementing payment without transforming hardware devices or adding a new physical chip, which can avoid a loss of account funds when technologies such as NFC are used to deduct account funds stored by the physical chip, thereby effectively improving the account security.

Referring to FIG. 3, FIG. 3 is a schematic flowchart of another electronic account data transfer method disclosed by an embodiment of the present disclosure. The method described in FIG. 3 is mainly described from the side of a payment server. The payment server may be a third-party payment server, a bank payment server, or another payment server, which is not limited in some embodiments. As shown in FIG. 3, the method may include the following steps.

S301: A payment server receives payment verification information sent by a payee client device, where the payment verification information includes a payer account identifier.

S302: The payment server determines a usage state of the payment verification information according to a stored state identifier of the payment verification information.

In some embodiments, the state identifier of the payment verification information may be indicated by one bit, for example, when the stored state identifier of the payment verification information is 1, the payment server can determine that the usage state of the payment verification information is an unused state according to the stored state identifier of the payment verification information, and when the stored state identifier of the payment verification information is 0, the payment server can determine that the usage state of the payment verification information is a used state according to the stored state identifier of the payment verification information.

S303: If the usage state of the payment verification information is an unused state, the payment server transfers a payment amount corresponding to the payment verification information from a payer account, to which the payer account identifier included in the payment verification information belongs, to a payee account.

In some embodiments, if the usage state of the payment verification information is a used state, the payment server may discard the payment verification information. Optionally, the payment server may further send information indicating that the payment verification information has been used to the payee client device.

In some embodiments, the payee client device may send the payment verification information to the payment server by using request information, where the request information may carry a payee client device identifier, and correspondingly, the payment server may learn a payee account number bound to the payee client device identifier according to the payee client device identifier. In an embodiment, the request information may directly carry the payee account number, which is not limited in some embodiments.

In some implementations, in the method described in FIG. 3, after performing Step S301 and before performing Step S302, the payment server may further perform the following step:

The payment server verifies whether the payment verification information is valid, if the payment verification information is verified to be valid, performs step S302, and on the contrary, if the payment verification information is verified to be invalid, discards the payment verification information. Optionally, if the payment verification information is verified to be invalid, the payment server may further send, to the payee client device, information indicating that the verification on the payment verification information fails.

In some implementations, in the method described in FIG. 3, after performing Step S303, the payment server may further perform the following step:

The payment server modifies the stored state identifier of the payment verification information, so that the usage state indicated by the modified state identifier of the payment verification information is a used state. For example, the payment server may modify the stored state identifier of the payment verification information from 1 to 0, so that it can be determined according to the stored state identifier of the payment verification information that the usage state of the payment verification information is a used state.

In some implementations, in the method described in FIG. 3, before performing Step S301, the payment server may further perform the following steps:

Step 31: The payment server receives a payment verification information request sent by the payer client device, where the payment verification information request includes the payer account and the payment amount.

Step 32: The payment server verifies whether the payer account included in the payment verification information request is valid, and if yes, generates the payment verification information corresponding to the payment amount, where the payment verification information corresponding to the payment amount includes the payer account identifier.

In some embodiments, the payment server may check whether the payer account included in the payment verification information request is the same as a stored payer account corresponding to a payer client device identifier, and if yes, the payer account included in the payment verification information request is verified to be valid; otherwise, the payer account included in the payment verification information request is invalid.

In some embodiments, after generating the payment verification information corresponding to the payment amount, the payment server may further block the payment amount from the payer account.

Step 33: The payment server sends the payment verification information corresponding to the payment amount to the payer client device.

In some embodiments, the payment verification information corresponding to the payment amount and sent by the payment server may include a plurality of signatures. For example, when the payment amount included in the payment verification information request is 100, the payer client device may receive payment verification information including 100 signatures and sent by the payment server. Each signature may include the payer account identifier, and optionally, each signature may further include a payer client device identifier, a signature serial number, and other necessary information, such as a signature generating timestamp, and so on.

In some embodiments, the payment server may use a private key of an asymmetric cryptographic algorithm as a signature, while a public key can be open to the payee client device, so that the payee client device can verify the signature string by using the public key.

In some embodiments, the payment server may use an abstract algorithm (such as SHA-1, DM5, and so on) to generate an abstract for the above information, and use the private key to encrypt the generated abstract content to generate a signature.

In the method described in FIG. 3, a client device commonly used at present can be directly used for implementing payment without transforming hardware devices or adding a new physical chip, which can avoid a loss of account funds when technologies such as NFC are used to deduct account funds stored by the physical chip, thereby effectively improving the account security.

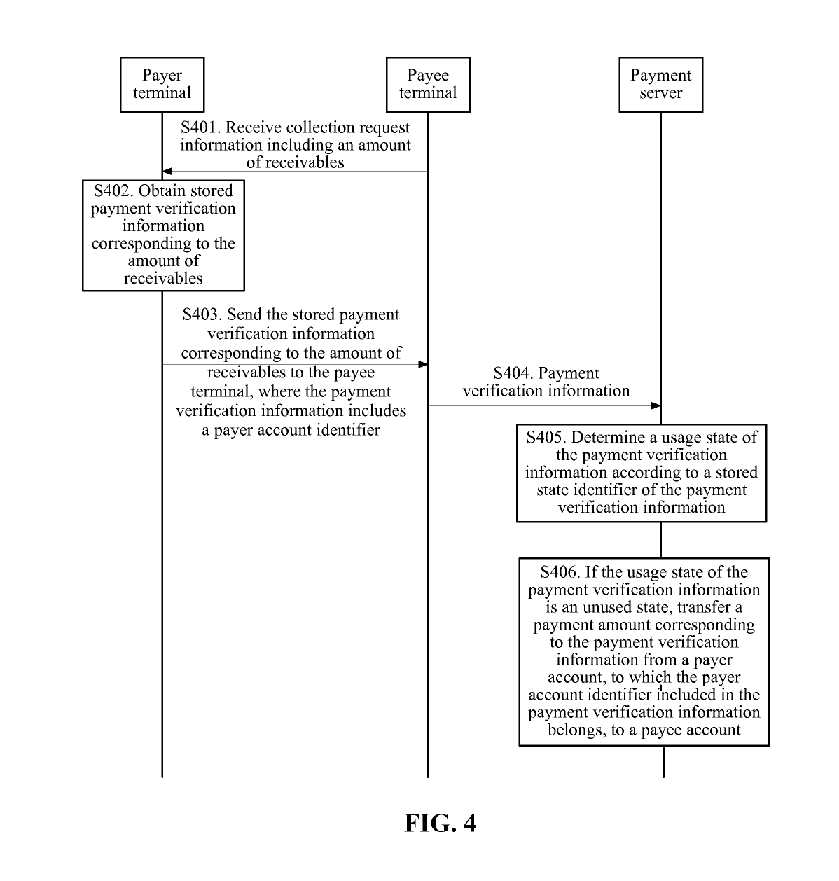

Referring to FIG. 4, FIG. 4 is a schematic flowchart of another electronic account data transfer method disclosed by an embodiment of the present disclosure. The method described in FIG. 4 is mainly described from the side of a payer client device, the side of a payee client device, and the side of a payment server. As shown in FIG. 4, the method may include the following steps.

S401: A payer client device receives collection request information including an amount of receivables and sent by a payee client device.

In some implementations, after receiving the collection request information including the amount of receivables and sent by the payee client device, the payer client device may output the collection request information, and after detecting an acknowledgment operation input by the payer in response to the collection request information, the payer client device performs Step S402.

S402: The payer client device obtains, in response to the collection request information, stored payment verification information corresponding to the amount of receivables.

In some embodiments, assuming that the amount of receivables included in the collection request information is 20, the payer client device may obtain, in response to the collection request information, payment verification information corresponding to 20, that is, the payment verification information may include 20 signatures.

S403: The payer client device sends the stored payment verification information corresponding to the amount of receivables to the payee client device, where the payment verification information includes a payer account identifier.

S404: The payee client device receives the payment verification information sent by the payer client device, and sends the payment verification information to the payment server.

S405: The payment server receives the payment verification information sent by the payee client device, and determines a usage state of the payment verification information according to a stored state identifier of the payment verification information.

S406: If the usage state of the payment verification information is an unused state, the payment server transfers a payment amount corresponding to the payment verification information from a payer account, to which the payer account identifier included in the payment verification information belongs, to a payee account.

In the method described in FIG. 4, a client device commonly used at present can be directly used for implementing payment without transforming hardware devices or adding a new physical chip, which can avoid a loss of account funds when technologies such as NFC are used to deduct account funds stored by the physical chip, thereby effectively improving the account security.

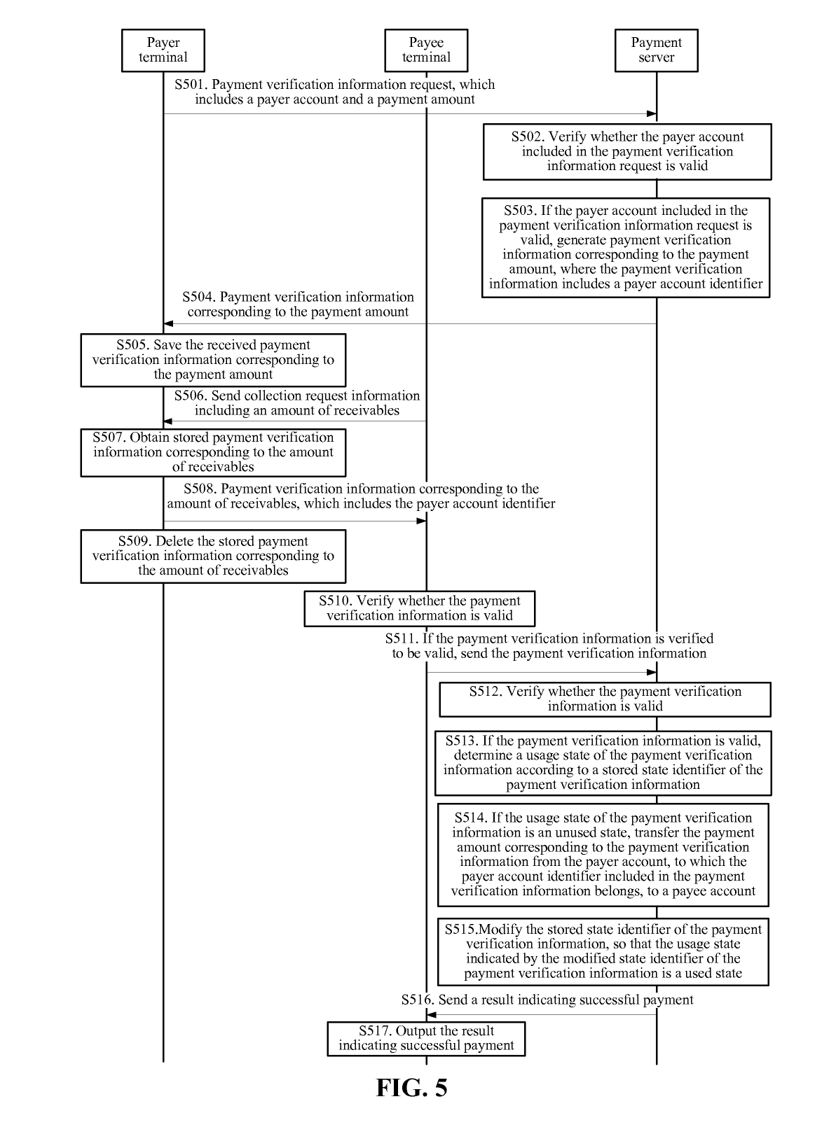

Referring to FIG. 5, FIG. 5 is a schematic flowchart of another electronic account data transfer method disclosed by an embodiment of the present disclosure. The method described in FIG. 5 is mainly described from the side of a payer client device, the side of a payee client device, and the side of a server. As shown in FIG. 5, the method may include the following steps.

S501: A payer client device sends a payment verification information request to a payment server, where the payment verification information request includes a payer account and a payment amount.

In some embodiments, the payer client device may detect an operation input by a user, and send the payment verification information request to the payment server in response to the operation.

S502: The payment server receives the payment verification information request sent by the payer client device, and verifies whether the payer account included in the payment verification information request is valid.

In some embodiments, a specific process in which the payment server verifies whether the payer account included in the payment verification information request is valid has been described in the foregoing embodiment, and is not described herein again.

Step 503: If the payer account included in the payment verification information request is verified to be valid, the payment server generates payment verification information corresponding to the payment amount, where the payment verification information corresponding to the payment amount includes a payer account identifier.

In some embodiments, the payment server may generate the payer account identifier according to the payer account.

In some embodiments, after generating the payment verification information corresponding to the payment amount, the payment server may further block the payment amount from the payer account.

S504: The payment server sends the payment verification information corresponding to the payment amount to the payer client device.

S505: The payer client device saves the received payment verification information corresponding to the payment amount.

S506: A payee client device sends collection request information including an amount of receivables to the payer client device.

S507: The payer client device receives the collection request information including the amount of receivables and sent by the payee client device, and obtains, in response to the collection request information, stored payment verification information corresponding to the amount of receivables.

In some implementations, after receiving the collection request information including the amount of receivables and sent by the payee client device, the payer client device may output the collection request information, and after detecting an acknowledgment operation input by the payer in response to the collection request information, the payer client device performs the step of obtaining, in response to the collection request information, stored payment verification information corresponding to the amount of receivables.

In some embodiments, assuming that the amount of receivables included in the collection request information is 20, the payer client device may obtain, in response to the collection request information, payment verification information corresponding to 20, and the payment verification information may include 20 signatures.

S508: The payer client device sends the payment verification information corresponding to the amount of receivables to the payee client device, where the payment verification information includes a payer account identifier.

S509: The payer client device deletes the stored payment verification information corresponding to the amount of receivables.

S510: The payee client device receives the payment verification information sent by the payer client device, and verifies whether the payment verification information is valid; if the payment verification information is verified to be valid, the payee client device performs Step S511; on the contrary, if the payment verification information is verified to be invalid, the payee client device may indicate that the verification on the payment verification information fails.

Step S509 and Step S510 may be performed at the same time, or Step S510 may be performed before Step S509, which is not limited in some embodiments.

S511: The payee client device sends the payment verification information to the payment server.

In some implementations, in Step S511, the payee client device may detect whether a network connection to the payment server exists, and if the network connection exists, the payee client device sends the payment verification information to the payment server; on the contrary, if no network connection exists, the payee client device may save the payment verification information, and sends the payment verification information to the payment server when a network connection exists.

In some implementations, in the method described in FIG. 3, after the payee client device detects that no network connection to the payment server exists and saves the payment verification information, the payee client device may send first prompt information to the payer client device, where the first prompt information is used for indicating that the payment verification information has been verified and saved by the payee client device, and is waiting for a payment operation, so that the payer can learn a payment execution process in time.

In some implementations, in the method described in FIG. 3, after sending the payment verification information to the payment server, the payee client device may also send second prompt information to the payer client device, where the second prompt information is used for indicating that the payment verification information has been sent to the payment server for a payment operation, so that the payer can learn a payment execution process in time.

S512: The payment server receives the payment verification information sent by the payee client device, and verifies whether the payment verification information is valid; if the payment verification information is verified to be valid, the payment server performs Step S513; on the contrary, if the payment verification information is verified to be invalid, the payment server may send, to the payee client device, information indicating that the verification on the payment verification information fails.

S513: The payment server determines a usage state of the payment verification information according to a stored state identifier of the payment verification information, if the usage state of the payment verification information is an unused state, performs Step S514, and on the contrary, if the usage state of the payment verification information is a used state, discards the payment verification information.

S514: The payment server transfers the payment amount corresponding to the payment verification information from the payer account, to which the payer account identifier included in the payment verification information belongs, to a payee account.

S515: The payment server modifies the stored state identifier of the payment verification information, so that the usage state indicated by the modified state identifier of the payment verification information is a used state.

S516: The payment server sends a result indicating successful payment to the payee client device.

S517: The payee client device outputs the result indicating successful payment.

In the method described in FIG. 5, a client device commonly used at present can be directly used for implementing payment without transforming hardware devices or adding a new physical chip, which can avoid a loss of account funds when technologies such as NFC are used to deduct account funds stored by the physical chip, thereby effectively improving the account security.

It should be noted that the method described in the foregoing method not only applies to a scenario where both the payer and payee are offline, but also applies to a scenario where the payee is online and the payer is offline, and a scenario where both the payer and payee are online.

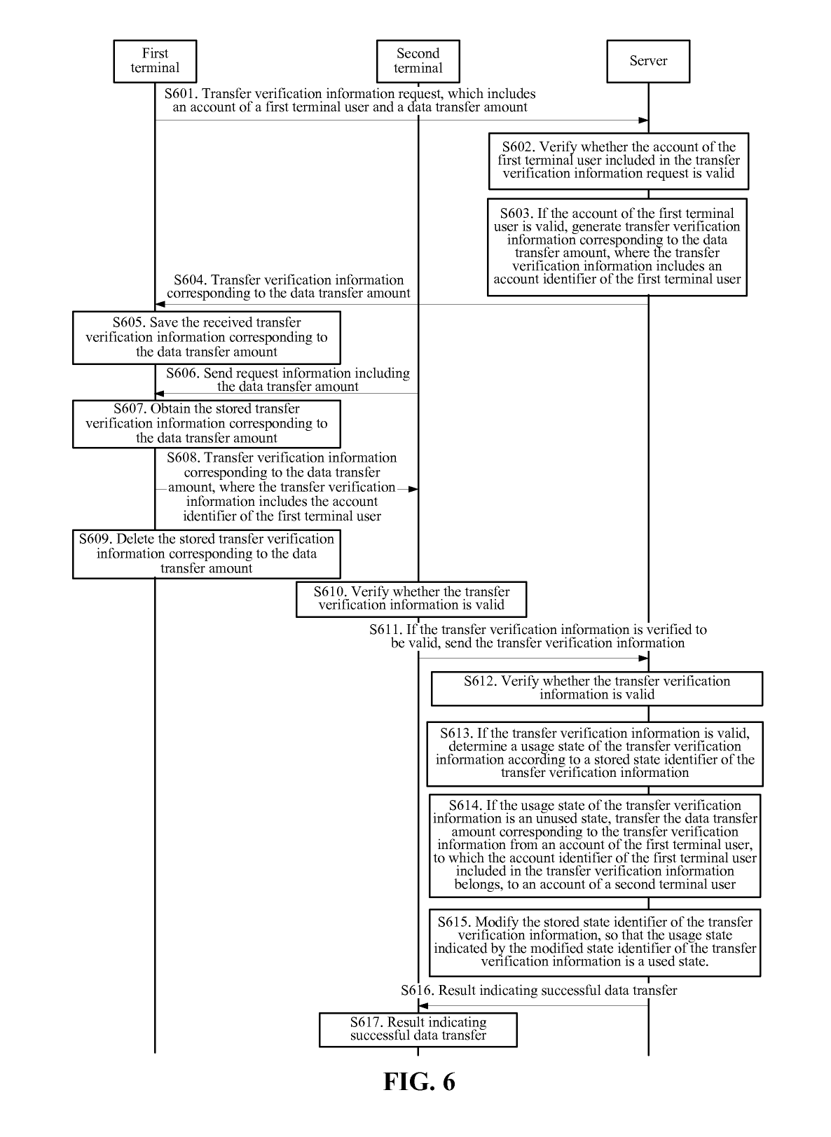

Referring to FIG. 6, FIG. 6 is a schematic flowchart of an electronic account data transfer method disclosed by an embodiment of the present disclosure. The electronic account data transfer method described in FIG. 6 is mainly described from the side of a first client device, the side of a second client device, and the side of a server. It should be noted that, the electronic account data transfer method described in FIG. 6 can be viewed from the perspective of the first client device side, the second client device side, or the server side alone, which does not affect the comprehension on the electronic account data transfer method disclosed by some embodiments. As shown in FIG. 6, the electronic account data transfer method may include the following steps.

S601: A first client device sends a transfer verification information request to a server, where the transfer verification information request includes an account of a first client device user and a data transfer amount.

In this embodiment, the first client device includes the foregoing payer client device, the transfer verification information request includes the foregoing payment verification information request, the account of the first client device user includes the foregoing payer account, the data transfer amount includes the payment amount, and the server includes the payment server.

In some embodiments, the first client device may detect an operation input by a user, and send the transfer verification information request to the server in response to the operation.

S602: The server receives the transfer verification information request sent by the first client device, and verifies whether the account of the first client device user included in the transfer verification information request is valid.

In some embodiments, a specific process in which the server verifies whether the account of the first client device user included in the transfer verification information request is valid is similar to the specific process in which the payment server verifies whether the payer account included in the payment verification information request is valid described in the foregoing embodiment, and is not described herein again.

S603: If the account of the first client device user included in the transfer verification information request is verified to be valid, the server generates transfer verification information corresponding to the data transfer amount, where the transfer verification information corresponding to the data transfer amount includes an account identifier of the first client device user.

In some embodiments, the server may generate the account identifier of the first client device user according to the account of the first client device user.

In some embodiments, after generating the transfer verification information corresponding to the data transfer amount, the server may block the data transfer amount from the account of the first client device user.

S604: The server sends the transfer verification information corresponding to the data transfer amount to the first client device.

S605: The first client device saves the received transfer verification information corresponding to the data transfer amount.

S606: A second client device sends request information including the data transfer amount to the first client device.

In some embodiments, the second client device includes a payee client device.

S607: The first client device receives the request information including the data transfer amount and sent by the second client device, and obtains, in response to the request information, the stored transfer verification information corresponding to the data transfer amount.

In some implementations, after receiving the request information including the data transfer amount and sent by the second client device, the first client device may output the request information, and after detecting an acknowledgment operation input in response to the request information, the first client device performs the step of obtaining, in response to the request information, stored transfer verification information corresponding to the data transfer amount.

In some embodiments, assuming that the data transfer amount included in the request information is 20, the first client device may obtain, in response to the request information, transfer verification information corresponding to 20, and the transfer verification information may include 20 signatures. In other words, the transfer verification information may include a plurality of signatures corresponding to the data transfer amount, and optionally, each signature includes the account identifier of the first client device user and a signature serial number.

S608: The first client device sends stored transfer verification information corresponding to the data transfer amount to the second client device, where the transfer verification information includes the account identifier of the first client device user.

S609: The first client device deletes the stored transfer verification information corresponding to the data transfer amount.

In an embodiment, Step S609 may be omitted, which is not limited in some embodiments.

S610: The second client device receives the transfer verification information sent by the first client device, and verifies whether the transfer verification information is valid; if the transfer verification information is verified to be valid, the second client device performs Step S611; on the contrary, if the transfer verification information is verified to be invalid, the second client device may indicate that the verification on the transfer verification information fails.

Step S609 and Step S610 may be performed at the same time, or Step S610 may be performed before Step S609, which is not limited in some embodiments.

In an embodiment, Step S609 and Step S610 may be omitted, which is not limited in some embodiments.

S611: The second client device sends the transfer verification information to the server.

In some implementations, in Step S611, the second client device may detect whether a network connection to the server exists, and if the network connection exists, the second client device sends the transfer verification information to the server; on the contrary, if no network connection exists, the second client device may save the transfer verification information, and send the transfer verification information to the server when a network connection exists.

In some implementations, in the method described in FIG. 6, after the second client device detects that no network connection to the server exists and saves the transfer verification information, the second client device may send first prompt information to the first client device, where the first prompt information is used for indicating that the transfer verification information has been verified and saved by the second client device, and is waiting for a data transfer operation, so that the first client device can learn a data transfer execution process in time.

In some implementations, in the method described in FIG. 6, after sending the transfer verification information to the server, the second client device may also send second prompt information to the first client device, where the second prompt information is used for indicating that the transfer verification information has been sent to the server for a data transfer operation, so that the first client device can learn a data transfer execution process in time.

S612: The server receives the transfer verification information sent by the second client device, and verifies whether the transfer verification information is valid; if the transfer verification information is verified to be valid, the server performs Step S613; on the contrary, if the transfer verification information is verified to be invalid, the server may send, to the second client device, information indicating that the verification on the transfer verification information fails.

In an embodiment, after receiving transfer transaction information sent by the second client device, the server does not need to verify whether the transfer verification information is valid, but directly performs Step S613, which is not limited in some embodiments.

S613: The server determines a usage state of the transfer verification information according to a stored state identifier of the transfer verification information, if the usage state of the transfer verification information is an unused state, performs Step S614, and on the contrary, if the usage state of the transfer verification information is a used state, discards the transfer verification information.

S614: The server transfers the data transfer amount corresponding to the transfer verification information from an account of the first client device user, to which the account identifier of the first client device user included in the transfer verification information belongs, to an account of a second client device user.

S615: The server modifies the stored state identifier of the transfer verification information, so that the usage state indicated by the modified state identifier of the transfer verification information is a used state.

S616: The server sends a result indicating successful data transfer to the second client device.

S617: The second client device outputs the result indicating successful data transfer.

In the method described in FIG. 6, a client device commonly used at present can be directly used to transfer data in the account without transforming hardware devices or adding a new physical chip, which can avoid a data loss when technologies such as NFC are used to deduct data from the account stored by the physical chip, thereby effectively improving the account security.

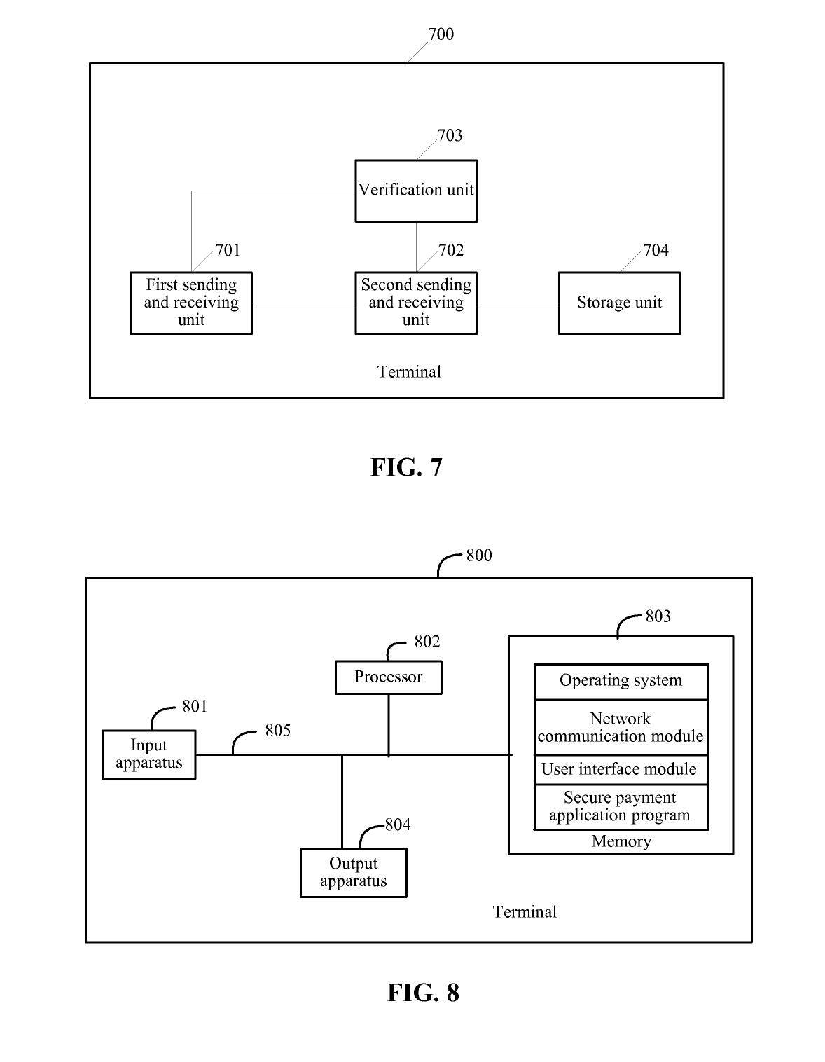

Referring to FIG. 7, FIG. 7 is a schematic structural diagram of a client device disclosed by an embodiment of the present disclosure. As shown in FIG. 7, the client device 700 may include:

a first sending and receiving unit 701, used for sending request information including a data transfer amount to a first client device, and receiving transfer verification information corresponding to the data transfer amount and sent by the first client device, where the transfer verification information includes an account identifier of a first client device user; and

a second sending and receiving unit 602, used for sending the transfer verification information received by the first sending and receiving unit 601 to a server, so that when the server determines that a usage state of the transfer verification information is an unused state according to a stored state identifier of the transfer verification information, the server transfers the data transfer amount corresponding to the transfer verification information from an account of the first client device user, to which the account identifier of the first client device user included in the transfer verification information belongs, to an account of a user of the present client device.

In some implementations, in the client device shown in FIG. 7, the client device 700 further includes:

a verification unit 703, used for: after the first sending and receiving unit 701 receives the transfer verification information corresponding to the data transfer amount and sent by the first client device, verifying whether the transfer verification information is valid, and if the transfer verification information is verified to be valid, triggering the second sending and receiving unit 702 to send the transfer verification information received by the first sending and receiving unit 701 to a server.

In some implementations, in the client device shown in FIG. 7, the second sending and receiving unit 702 is used for detecting whether a network connection to the server exists, and if the network connection exists, sending the transfer verification information to the server; optionally, the client device 700 further includes a storage unit 704, used for saving the transfer verification information received by the first sending and receiving unit 701 when the second sending and receiving unit 702 detects that no network connection to the server exists. When the second sending and receiving unit 702 detects that a network connection to the server exists, the second sending and receiving unit 702 may send the transfer verification information stored by the storage unit 704 to the server.

In an embodiment, after the storage unit 704 stores the transfer verification information, the second sending and receiving unit 702 is further used for sending first prompt information to the first client device, where the first prompt information is used for indicating that the transfer verification information has been verified and saved, and is waiting for a data transfer operation, so that the first client device can learn a data transfer execution process in time. In an embodiment, the second sending and receiving unit 702 is further used for sending second prompt information to the first client device after sending the transfer verification information to the server, where the second prompt information is used for indicating that the transfer verification information has been sent to the server for a data transfer operation, so that the first client device can learn a data transfer execution process in time.

In some embodiments, the transfer verification information may include a plurality of signatures corresponding to the data transfer amount, where each signature includes the account identifier of the first client device user and a signature serial number.

The client device described in FIG. 7 can avoid a data loss when technologies such as NFC are used to deduct data from the account stored by the physical chip, thereby effectively improving the account security.

Referring to FIG. 8, FIG. 8 is a schematic structural diagram of another client device disclosed by an embodiment of the present disclosure. As shown in FIG. 8, the client device 800 may include an input apparatus 801, a processor 802, a memory 803, an output apparatus 804, and a communication bus 805. The communication bus 805 is used for implementing connection communication among these components. As shown in FIG. 8, the memory 803, as a computer storage medium, may include an operating system, a network communication module, a user interface module, and a data transfer application program.

In the client device shown in FIG. 8, the processor 802 may be used for invoking the data transfer application program stored in the memory 803, and performing the following operations:

sending, by using the output apparatus 804, request information including a data transfer amount to a first client device;

receiving, by using the input apparatus 801, transfer verification information corresponding to the data transfer amount and sent by the first client device, where the transfer verification information includes an account identifier of a first client device user; and

sending, by using the output apparatus 804, the transfer verification information to a server, so that when the server determines that a usage state of the transfer verification information is an unused state according to a stored state identifier of the transfer verification information, the server transfers the data transfer amount corresponding to the transfer verification information from an account of the first client device user, to which the account identifier of the first client device user included in the transfer verification information belongs, to an account of a user of the present client device.

As another optional implementation manner, after receiving, by using the input apparatus 801, the transfer verification information corresponding to the data transfer amount and sent by the first client device, and before sending, by using the output apparatus 804, the transfer verification information to the server, the processor 802 further performs the following operation:

verifying whether the transfer verification information is valid, and if the transfer verification information is verified to be valid, performing the step of sending, by using the output apparatus 804, the transfer verification information to a server.

As another optional implementation manner, the step of the processor 802 sending, by using the output apparatus 804, the transfer verification information to a server includes:

detecting whether a network connection to a server exists, and if the network connection exists, the processor 802 sending, by using the output apparatus 804, the transfer verification information to the server.

As another optional implementation manner, if detecting that no network connection to the server exists, the processor 802 may further save the transfer verification information in the memory 803. After detecting that a network connection to the server exists, the processor 802 sends, by using the output apparatus 804, the transfer verification information stored by the memory 803 to the server.

In some embodiments, the transfer verification information may include a plurality of signatures corresponding to the data transfer amount, where each signature includes the account identifier of the first client device user and a signature serial number.

The client device described in FIG. 8 can avoid a data loss when technologies such as NFC are used to deduct data from the account stored by the physical chip, thereby effectively improving the account security.

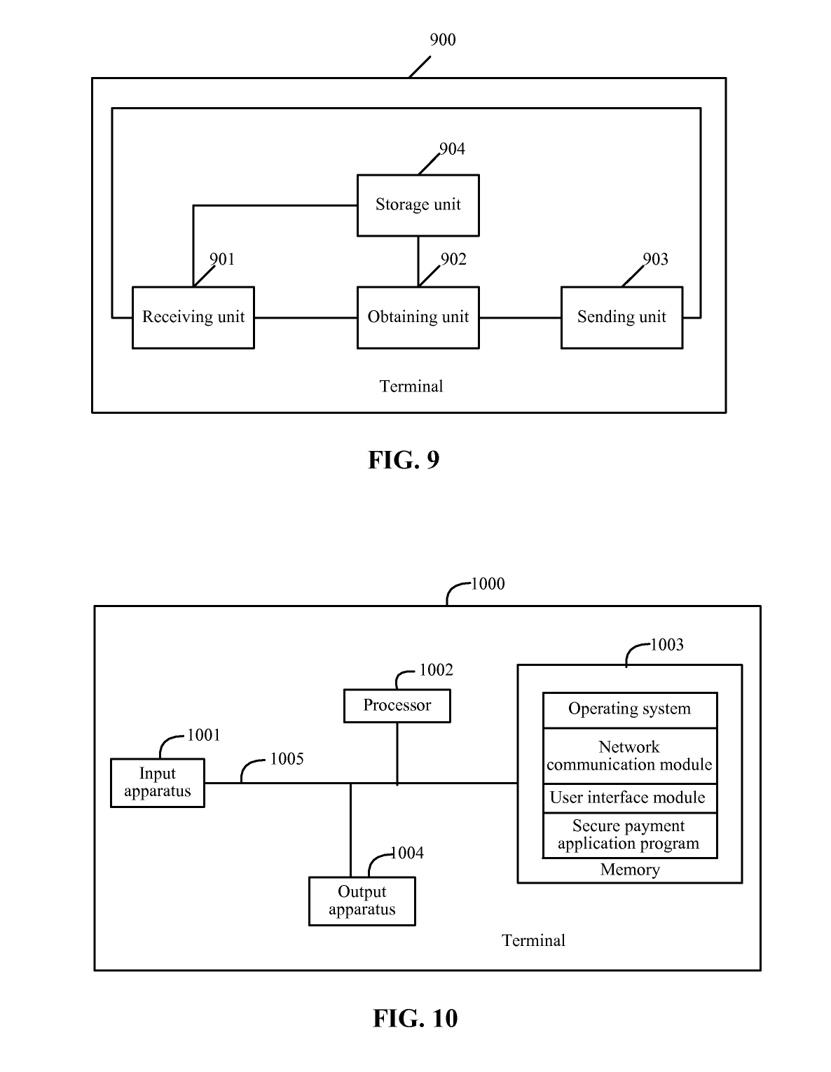

Referring to FIG. 9, FIG. 9 is a schematic structural diagram of another client device disclosed by an embodiment of the present disclosure. As shown in FIG. 9, the client device 900 includes:

a receiving unit 901, used for receiving request information including a data transfer amount and sent by a second client device;

an obtaining unit 902, used for obtaining, in response to the request information, stored transfer verification information corresponding to the data transfer amount; and

a sending unit 903, used for sending the transfer verification information to the second client device, where the transfer verification information includes an account identifier of a user of the present client device (namely, the client device 900), so that the second client device sends the transfer verification information to a server, and when the server determines that a usage state of the transfer verification information is an unused state according to a stored state identifier of the transfer verification information, the server transfers the data transfer amount corresponding to the transfer verification information from an account of the user of the present client device, to which the account identifier of the user of the present client device included in the transfer verification information belongs, to an account of a second client device user.

In some implementations, in the client device described in FIG. 9, the sending unit 903 is further used for sending a transfer verification information request to the server, where the transfer verification information request includes the account of the user of the present client device and the data transfer amount, so that the server generates the transfer verification information corresponding to the data transfer amount after verifying that the account of the user of the present client device included in the transfer verification information request is valid, where the transfer verification information corresponding to the data transfer amount includes the account identifier of the user of the present client device.

Correspondingly, the receiving unit 901 is further used for receiving the transfer verification information corresponding to the data transfer amount and sent by the server.

Correspondingly, the client device 900 further includes a storage unit 904, used for saving the received transfer verification information corresponding to the data transfer amount. In other words, the obtaining unit 902 may obtain, in response to the request information, the stored transfer verification information corresponding to the data transfer amount from the storage unit 904.

In an embodiment, the storage unit 904 is further used for: after the sending unit 903 sends the transfer verification information to the second client device, deleting the stored transfer verification information.

In some embodiments, the transfer verification information includes a plurality of signatures corresponding to the data transfer amount, where each signature includes the account identifier of the user of the present client device and a signature serial number.

The client device described in FIG. 9 can avoid a data loss when technologies such as NFC are used to deduct data from the account stored by the physical chip, thereby effectively improving the account security.

Referring to FIG. 10, FIG. 10 is a schematic structural diagram of another client device disclosed by an embodiment of the present disclosure. As shown in FIG. 10, the client device 1000 may include an input apparatus 1001, a processor 1002, a memory 1003, an output apparatus 1004, and a communication bus 1005. The communication bus 1005 is used for implementing connection communication among these components. As shown in FIG. 10, the memory 1003, as a computer storage medium, may include an operating system, a network communication module, a user interface module, and a data transfer application program.

In the client device shown in FIG. 10, the processor 1002 may be used for invoking a secure payment application program stored in the memory 1003, and performing the following operations:

receiving, by using the input apparatus 1001, request information including a data transfer amount and sent by a second client device;

obtaining, in response to the request information, stored transfer verification information corresponding to the data transfer amount (for example, the memory 1003 stores the transfer verification information corresponding to the data transfer amount), and sending, by using the output apparatus 1004, the transfer verification information to the second client device, where the transfer verification information includes an account identifier of a user of the present client device, so that the second client device sends the transfer verification information to a server, and when the server determines that a usage state of the transfer verification information is an unused state according to a stored state identifier of the transfer verification information, the server transfers the data transfer amount corresponding to the transfer verification information from an account of the user of the present client device, to which the account identifier of the user of the present client device included in the transfer verification information belongs, to an account of a second client device user.

In some implementations, before receiving, by using the input apparatus 1001, the request information including the data transfer amount and sent by the second client device, the processor 1002 further performs the following operations:

sending, by using the output apparatus 1004, a transfer verification information request to the server, where the transfer verification information request includes the account of the user of the present client device and the data transfer amount, so that the server generates the transfer verification information corresponding to the data transfer amount after verifying that the account of the user of the present client device included in the transfer verification information request is valid, where the transfer verification information corresponding to the data transfer amount includes the account identifier of the user of the present client device;

receiving, by using the input apparatus 901, the transfer verification information corresponding to the data transfer amount and sent by the server; and

saving the received transfer verification information corresponding to the data transfer amount (for example, saving the transfer verification information in the memory 1003).

In some embodiments, the transfer verification information includes a plurality of signatures corresponding to the data transfer amount, where each signature includes the account identifier of the user of the present client device and a signature serial number.

The client device described in FIG. 10 can avoid a data loss when technologies such as NFC are used to deduct data from the account stored by the physical chip, thereby effectively improving the account security.

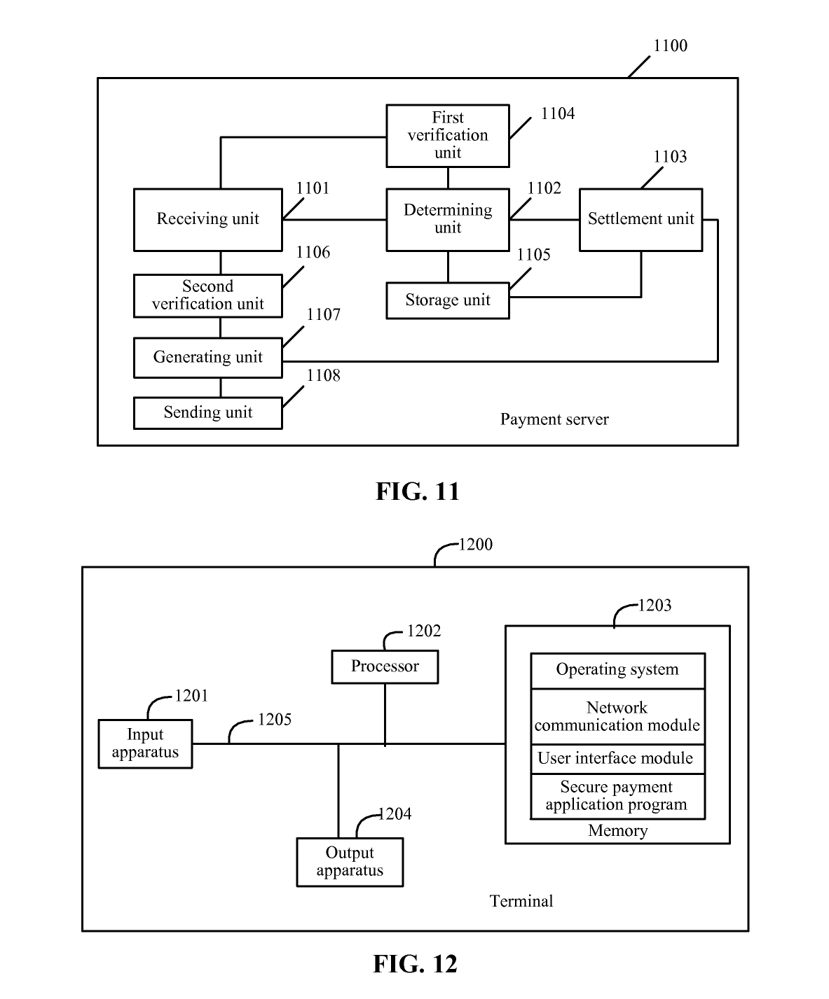

Referring to FIG. 11, FIG. 11 is a schematic structural diagram of a server disclosed by an embodiment of the present disclosure. As shown in FIG. 11, the server 1100 includes:

a receiving unit 1101, used for receiving transfer verification information sent by a second client device, where the transfer verification information includes an account identifier of a first client device user;

a determining unit 1102, used for determining a usage state of the transfer verification information according to a stored state identifier of the transfer verification information; and

a settlement unit 1103, used for: if the determining unit 1102 determines that the usage state of the transfer verification information is an unused state, transferring a data transfer amount corresponding to the transfer verification information from an account of the first client device user, to which the account identifier of the first client device user included in the transfer verification information belongs, to an account of a second client device user.

In some implementations, the server 1100 further includes:

a first verification unit 1104, used for verifying whether the transfer verification information received by the receiving unit 1101 is valid, and if the transfer verification information is verified to be valid, triggering the determining unit 1102 to determine the usage state of the transfer verification information according to the stored state identifier of the transfer verification information.

In some implementations, the server 1100 further includes:

a storage unit 1105, used for: after the settlement unit 1103 transfers the data transfer amount corresponding to the transfer verification information from the account of the first client device user, to which the account identifier of the first client device user included in the transfer verification information belongs, to the account of the second client device user, modifying the stored state identifier of the transfer verification information, so that the usage state indicated by the modified state identifier of the transfer verification information is a used state.

Correspondingly, the determining unit 1102 may determine a usage state of the transfer verification information according to a state identifier, stored by the storage unit 1105, of the transfer verification information.

In some implementations, in the server 1100, the receiving unit 1101 is further used for receiving a transfer verification information request sent by the first client device, where the transfer verification information request includes the account of the first client device user and the data transfer amount.

Correspondingly, the server 1100 further includes:

a second verification unit 1106, used for verifying whether the account of the first client device user included in the transfer verification information request is valid;

a generating unit 1107, used for generating the transfer verification information corresponding to the data transfer amount when the second verification unit 1106 verifies that the account of the first client device user included in the transfer verification information request is valid, where the transfer verification information corresponding to the data transfer amount includes the account identifier of the first client device user; and

a sending unit 1108, used for sending the transfer verification information corresponding to the data transfer amount to the first client device.

In an embodiment, the settlement unit 1103 is further used for: after the generating unit 1107 generates the transfer verification information corresponding to the data transfer amount, blocking the data transfer amount from the account of the first client device user.

In some embodiments, the second verification unit 1106 is used for checking whether the account of the first client device user included in the transfer verification information request is the same as a stored account corresponding to an identifier of the first client device, and if yes, verifying that the account of the first client device user included in the transfer verification information request is valid.

In some embodiments, the transfer verification information includes a plurality of signatures corresponding to the data transfer amount, where each signature includes the account identifier of the first client device user and a signature serial number.

The server described in FIG. 11 can avoid a data loss when technologies such as NFC are used to deduct data from the account stored by the physical chip, thereby effectively improving the account security.

Referring to FIG. 12, FIG. 12 is a schematic structural diagram of another server disclosed by an embodiment of the present disclosure. As shown in FIG. 12, the server 1200 may include an input apparatus 1201, a processor 1202, a memory 1203, an output apparatus 1204, and a communication bus 1205. The communication bus 1205 is used for implementing connection communication among these components. As shown in FIG. 12, the memory 1203, as a computer storage medium, may include an operating system, a network communication module, a user interface module, and a data transfer application program.

In the server shown in FIG. 12, the processor 1202 may be used for invoking the data transfer application program stored in the memory 1203, and performing the following operations:

receiving, by using the input apparatus 1201, transfer verification information sent by a second client device, where the transfer verification information includes an account identifier of a first client device user;

determining a usage state of the transfer verification information according to a stored state identifier of the transfer verification information; and

if the usage state of the transfer verification information is an unused state, transferring the data transfer amount corresponding to the transfer verification information from an account of the first client device user, to which the account identifier of the first client device user included in the transfer verification information belongs, to an account of a second client device user.

In some implementations, after receiving, by using the input apparatus 1201, the transfer verification information sent by the second client device, and before determining the usage state of the transfer verification information according to the stored state identifier of the transfer verification information, the processor 1202 may further perform the following operation:

verifying whether the transfer verification information is valid, and if the transfer verification information is verified to be valid, performing the step of determining a usage state of the transfer verification information according to a stored state identifier of the transfer verification information.

In some implementations, after transferring the data transfer amount corresponding to the transfer verification information from the account of the first client device user, to which the account identifier of the first client device user included in the transfer verification information belongs, to the account of the second client device user, the processor 1202 further performs the following operation:

modifying the stored state identifier of the transfer verification information, so that the usage state indicated by the modified state identifier of the transfer verification information is a used state, where the state identifier of the transfer verification information may be stored in the memory 1203.

In some implementations, before receiving, by using the input apparatus 1201, the transfer verification information sent by the second client device, the processor 1202 may further perform the following operations:

receiving, by using the input apparatus 1201, a transfer verification information request sent by the first client device, where the transfer verification information request includes the account of the first client device user and the data transfer amount;

verifying whether the account of the first client device user included in the transfer verification information request is valid, and if yes, generating the transfer verification information corresponding to the data transfer amount, where the transfer verification information corresponding to the data transfer amount includes the account identifier of the first client device user; and

sending, by using the output apparatus 1204, the transfer verification information corresponding to the data transfer amount to the first client device.

In some embodiments, the transfer verification information includes a plurality of signatures corresponding to the data transfer amount, where each signature includes the account identifier of the first client device user and a signature serial number.

The server described in FIG. 12 can avoid a data loss when technologies such as NFC are used to deduct data from the account stored by the physical chip, thereby effectively improving the account security.

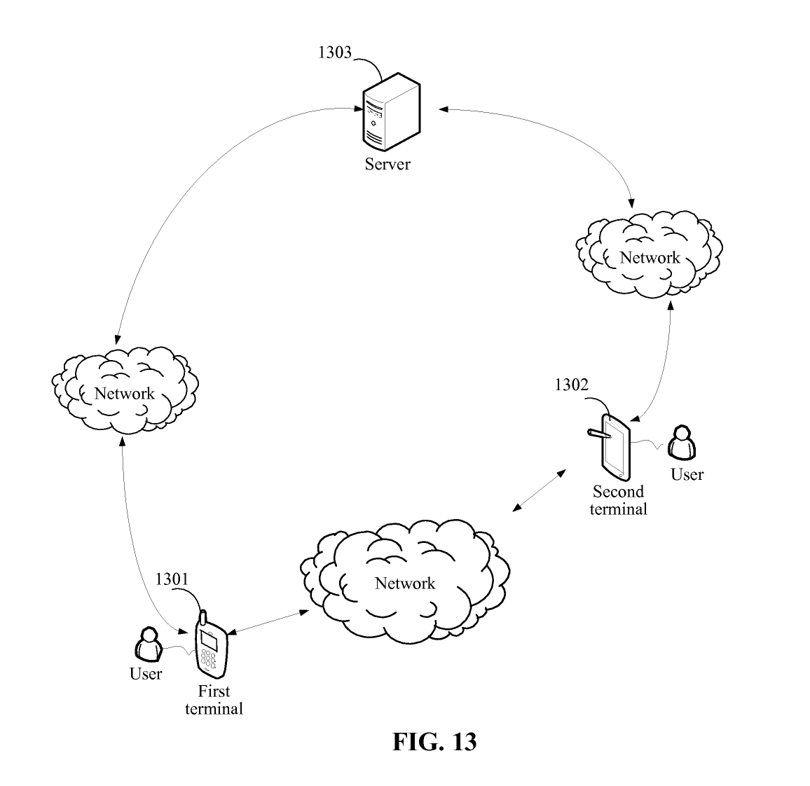

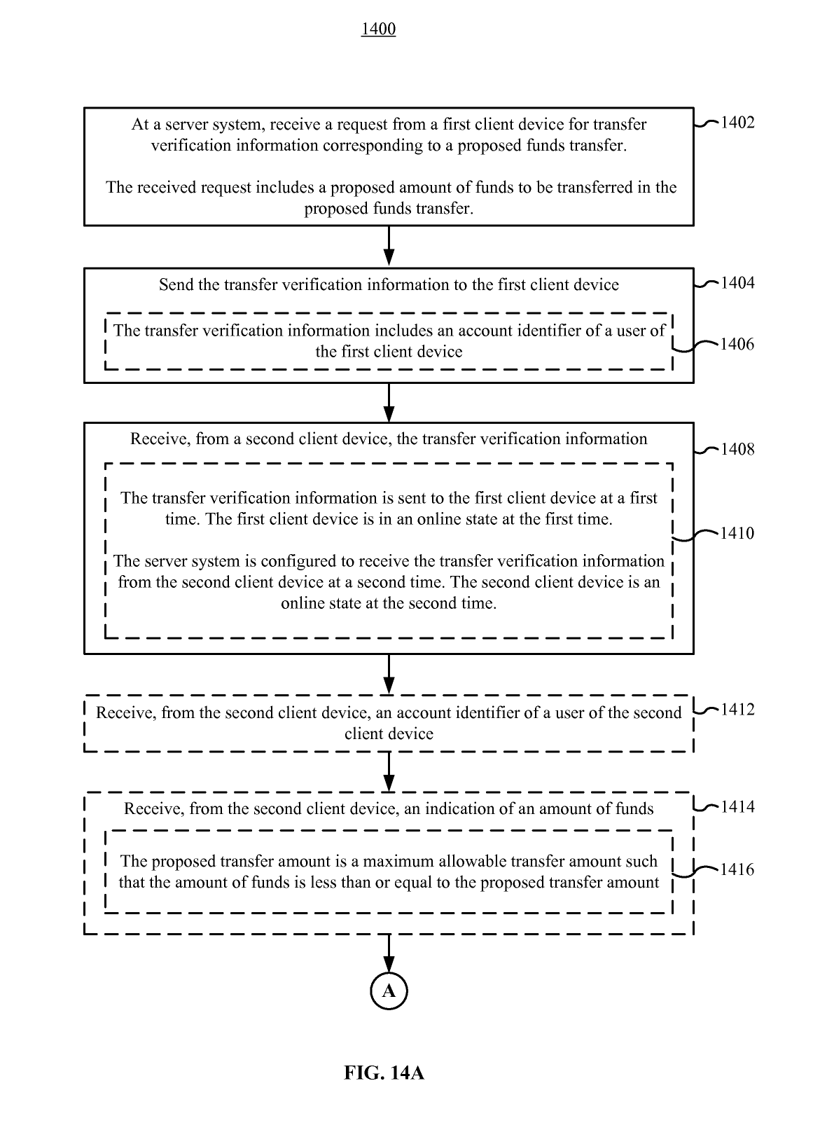

Referring to FIG. 13, FIG. 13 is a schematic structural diagram of an electronic account data transfer system disclosed by an embodiment of the present disclosure. The electronic account data transfer system includes a first client device 1301, a second client device 1302, and a server 1303.

The first client device 1301 is used for receiving request information including a data transfer amount and sent by the second client device 1302.

The first client device 1301 is further used for obtaining, in response to the request information, stored transfer verification information corresponding to the data transfer amount, and sending the transfer verification information to the second client device 1302, where the transfer verification information includes an account identifier of a first client device user.

The second client device 1302 is used for receiving the transfer verification information sent by the first client device 1301.

The second client device 1302 is further used for sending the transfer verification information to the server 1303.

The server 1303 is used for determining a usage state of the transfer verification information according to a stored state identifier of the transfer verification information, and if the usage state of the transfer verification information is an unused state, transferring the data transfer amount corresponding to the transfer verification information from an account of the first client device user, to which the account identifier of the first client device user included in the transfer verification information belongs, to an account of a second client device user.

In an embodiment, the second client device 1302 is further used for: after receiving the transfer verification information sent by the first client device 1301 and before sending the transfer verification information to the server 1303, verifying whether the transfer verification information is valid, and if the transfer verification information is verified to be valid, performing the step of sending the transfer verification information to the server 1303.

In an embodiment, a manner in which the second client device 1302 sends the transfer verification information to the server 1403 is specifically as follows:

the second client device 1302 detects whether a network connection to the server exists, and if the network connection exists, sends the transfer verification information to the server 1303.

In an embodiment, if the second client device 1302 detects that no network connection to the server 1303 exists, the second client device 1302 is further used for saving the transfer verification information, and sending first prompt information to the first client device 1301, where the first prompt information is used for indicating that the transfer verification information has been verified and saved by the second client device 1302, and is waiting for a payment operation, so that the first client device 1301 can learn a data transfer execution process in time.

In an embodiment, the second sending and receiving unit 1302 is further used for sending second prompt information to the first client device 1301 after sending the transfer verification information to the server 1303, where the second prompt information is used for indicating that the transfer verification information has been sent to the server 1303 for a data transfer operation, so that the first client device 1301 can learn a data transfer execution process in time.

In an embodiment, before determining the usage state of the transfer verification information according to the stored state identifier of the transfer verification information, the server 1303 is further used for verifying whether the transfer verification information is valid, and if the transfer verification information is verified to be valid, performing the step of determining a usage state of the transfer verification information according to a stored state identifier of the transfer verification information.

In an embodiment, the server is further used for: transferring the data transfer amount corresponding to the transfer verification information from the account of the first client device user, to which the account identifier of the first client device user included in the transfer verification information belongs, to the account of the second client device user, modifying the stored state identifier of the transfer verification information, so that the usage state indicated by the modified state identifier of the transfer verification information is a used state.

In an embodiment, before receiving the request information including the data transfer amount and sent by the second client device, first client device 1301 is further used for sending a transfer verification information request to the server 1303, where the transfer verification information request includes the account of the first client device user and the data transfer amount.

Correspondingly, the server 1303 is further used for receiving the transfer verification information request sent by the first client device 1301, verifying whether the account of the first client device user included in the transfer verification information request is valid, and if yes, generating the transfer verification information corresponding to the data transfer amount, where the transfer verification information corresponding to the data transfer amount includes the account identifier of the first client device user.

Correspondingly, the server 1303 is further used for sending the transfer verification information corresponding to the data transfer amount to the first client device 1301.

Correspondingly, the first client device 1301 is further used for saving the received transfer verification information corresponding to the data transfer amount.

In an embodiment, after generating the transfer verification information corresponding to the data transfer amount, the server 1303 is further used for blocking the data transfer amount from the account of the first client device user.

In some embodiments, a manner in which the server 1303 verifies whether the account of the first client device user included in the transfer verification information request is valid is specifically as follows:

the server 1303 is used for checking whether the account of the first client device user included in the transfer verification information request is the same as a stored account corresponding to an identifier of the first client device, and if yes, verifying that the account of the first client device user included in the transfer verification information request is valid.

In an embodiment, after sending the transfer verification information to the second client device, the first client device 1301 is further used for deleting the stored transfer verification information.

In some embodiments, the transfer verification information includes a plurality of signatures corresponding to the data transfer amount, where each signature includes the account identifier of the first client device user and a signature serial number.

It can be seen that, through the system shown in FIG. 13, a client device commonly used at present can be directly used to transfer data in the account without transforming hardware devices or adding a new physical chip, which can avoid a data loss when technologies such as NFC are used to deduct data from the account stored by the physical chip, thereby effectively improving the account security.

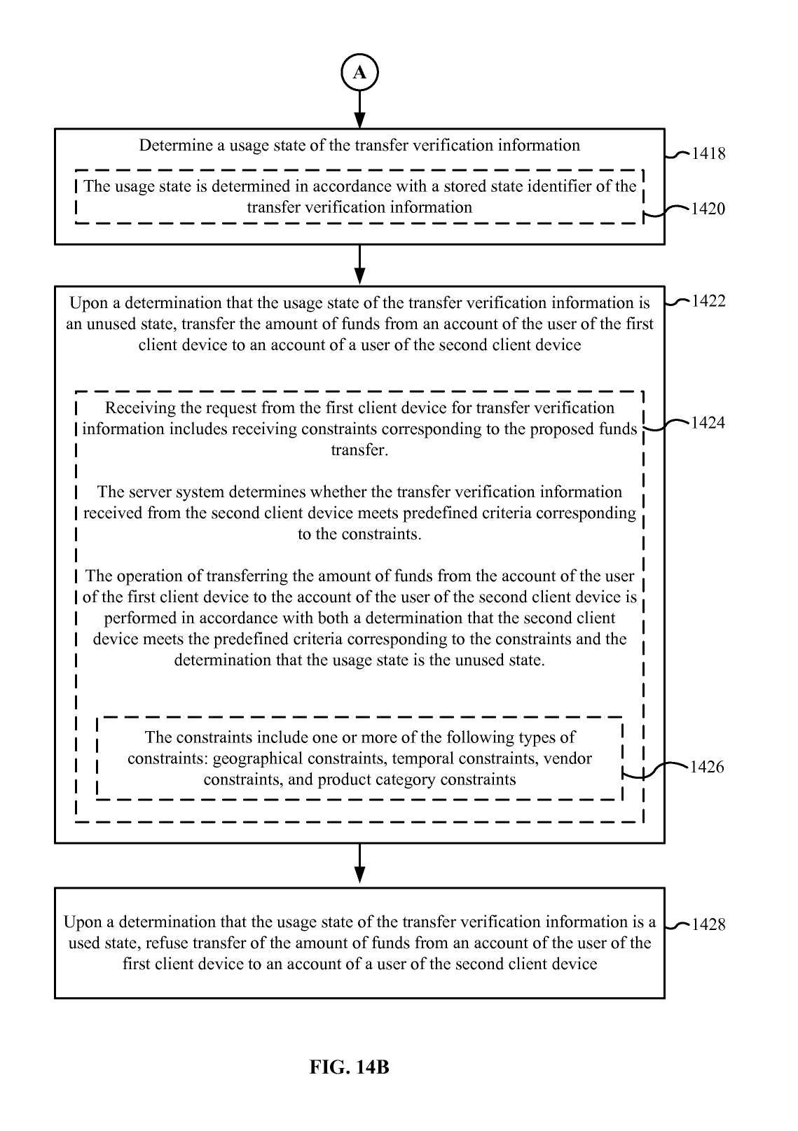

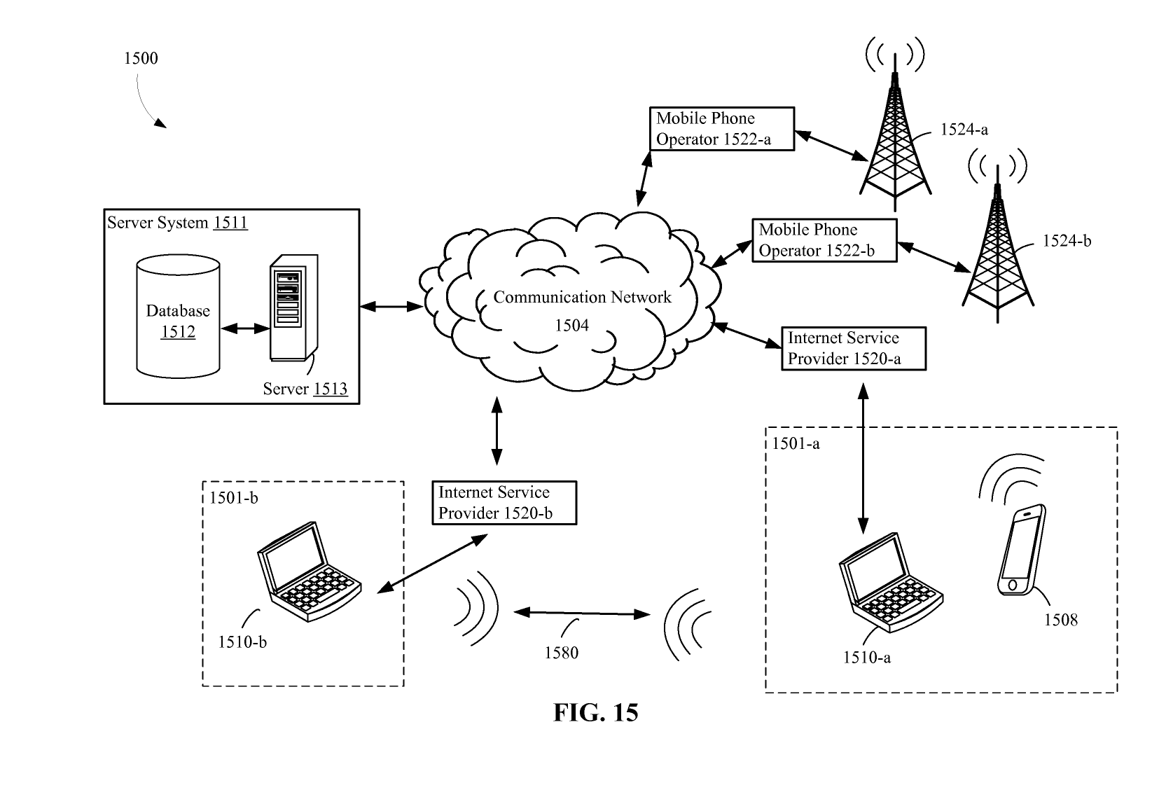

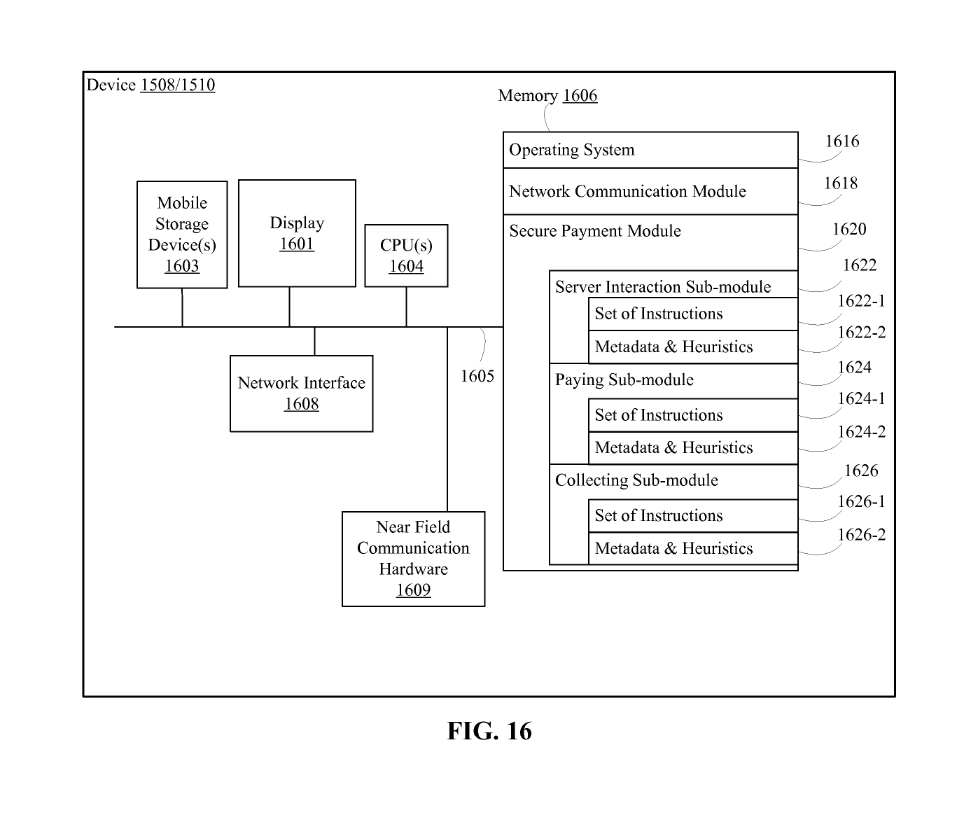

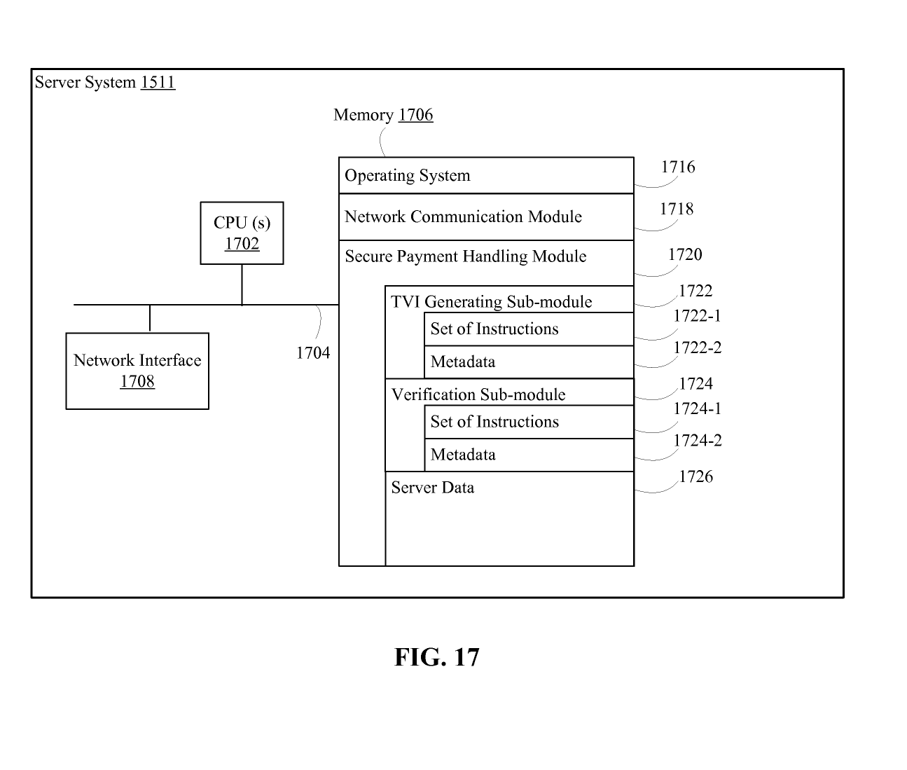

FIGS. 14A-14B include a flow chart of a method 1400 of handling a secure payment over a network, in accordance with some implementations. In some implementations, one or more operations in the method 1400 are performed at a portable device (e.g., client device 1508/1510, as described with reference to FIG. 15 and/or FIG. 16). In some implementations, one or more operations in the method 1400 are performed at a server system (e.g., server system 1511, as described with reference to FIG. 15 and/or FIG. 17).

A server system receives (1402) a request from a first client device for transfer verification information (e.g., payment verification information) corresponding to a proposed funds transfer. This is sometimes called a “transfer request” or “funds transfer request.” The received request includes a proposed amount of funds to be transferred in the proposed funds transfer.

In some embodiments, the first client device is a portable multifunction device such as a smart phone, tablet, smart watch, smart bracelet, or smart card. The first client device is sometimes regarded as the “payer” client device.

In some circumstances, the server system is a banking server system (e.g., the server system hosts a banking website) or a payment processing server system (e.g., the server system hosts a payment processing website, similar to PayPal or Venmo). In some embodiments, method 1400 is used to pre-approve transactions, or a budget for transactions, when there is a likelihood that the first client device will be offline (e.g., unable to connect to the server system) when the transaction is going to be made. For example, when a user of the first client device knows that he will be shopping in an area of unreliable network coverage (i.e., the network with which he connects to the server system), he can, in accordance with some embodiments, use a mobile on application on his mobile phone (i.e., the client device, in this example) to pre-load shopping funds (i.e., the amount of funds to be transferred, in this example). Alternatively, the user may pre-load the shopping funds on a separate client device (e.g., his personal computer or smart television) by logging into a webpage that accesses the same account for which the mobile application has access (herein referred to as “the first user's account). As explained in greater detail below, in some embodiments, the proposed amount of funds is a maximum amount of funds that can be transferred and hence is referred to as a “budget.”

In some embodiments, the request for transfer verification information is enciphered with a public key corresponding to the server system. In some embodiments, the public key corresponding to the server system is certified by a certification authority (CA).

In some embodiments, the request for transfer verification information includes an account identifier of the user of the first client device (i.e., the first user's account). The server system optionally performs one or more checks to determine the validity of the request, including determining whether the first user's account exists and/or determining whether the first user's account has sufficient funds (e.g., the proposed amount of funds is less than or equal to a balance on the first user's account). In some embodiments, the server system generates all or part of the transfer verification information, and optionally generates a data structure stored on the server system (e.g., in database 1512, FIG. 1) that corresponds to the transfer verification information. For example, in some embodiments, the server system will generate a digital signature (e.g., a public key) and include the digital signature in the transfer verification information as well as the data structure corresponding to the transfer verification information. For example, in some embodiments, the signature is generated using a cryptography algorithm such as SHA-1 (SHA is an acronym for secure hash algorithm). As explained in greater detail below, when an attempt is made to use the proposed funds, the server system will optionally perform a consistency check with the digital signature before allowing a transfer (e.g., transaction) to proceed.

The server system sends (1404) the transfer verification information to the first client device. In some embodiments, the transfer verification information includes (1406) an account identifier of the user of the first client device (e.g., a phone number, an account number, a log-in name, or an anonymous hashed version of any of the preceding). Alternatively, the transfer verification information does not include an account identifier of the user first client device and, instead, the account identifier of the first user's account is appended to the transfer verification information at a later time. In some embodiments, the first client device stores the transfer verification information.

The server system receives (1408), from a second client device, the transfer verification information. This is sometimes called a “collection request.” The second client device is sometimes regarded as the “payee” client device or, more simply, the “vendor.” In some circumstances, the second client device will have received the transfer verification information and/or the first user's account identifier from the first client device or a near field communication “tag” belonging to the first user but distinct from the first client device.

In some circumstances, the second client device is a portable multifunction device such as a smart phone, tablet, smart watch, smart bracelet, or smart card. In this manner, method 1400 is operable on both sides of a payer/vendor transaction with electronic equipment that is common to ordinary people (as opposed to established businesses). Thus, method 1400 can be used, in some circumstances, to exchange funds between friends or between shoppers and vendors at a flea market, farmer's market, or food truck. Alternatively, in some circumstances, the second client device is an electronic kiosk, cash register, parking meter, or the like.

In some embodiments, the second client device utilizes add-on hardware, such as USB (Universal Serial Bus) compatible RFID hardware (RFID is an acronym for radio frequency identification) to interact with the first client device (e.g., using near field communication (NFC)). By the same token, the first client device also optionally uses add-on hardware to interact with the second client device.

In some embodiments, the transfer verification information is sent (1410) to the first client device at a first time. The first client device is in an online state (e.g., in communication with a network through which the server system can be reached) at the first time. The server system is configured to receive the transfer verification information from the second client device at a second time. The second client device is an online state at the second time. In this manner, the second client device need not be in the online state at the first time while the first client device need not be in the online state at the second time. In addition, as noted above, in some embodiments, the first client device sends the transfer verification information to the second client device, which receives the transfer verification information. In some circumstances, this occurs at a third time, between the first time and the second time, when neither the first client device nor the second client device is in an online state (i.e., both the first client device and the second client device are in an offline state).

As one example, consider two friends, Alice and Bob. In this example, assume that the server system is for a payment processing service that allows users to transfer funds between one another, and that Alice and Bob are users of the payment processing service. To this end, Alice may communicate, at a first time, with the server system (e.g., via her client device) to pre-load funds for transfer (e.g., by requesting transfer verification information, as described above). At this point in time, Bob need not be connected (e.g., via his client device) to the server system. Later, at a third time, Alice may want to reimburse Bob for movie tickets. In some embodiments, this is realized by near field communication (NFC) between Alice's client device and Bob's client device. At the third time, in some circumstances, neither Alice's client device nor Bob's client device are connected to the network. In such circumstances, information corresponding to the transfer (e.g., the transfer verification information) is stored locally on Bob's device until Bob gains access to the network (e.g., is in an online state). In some embodiments, Bob's client device sends an acknowledgment to Alice's client device so that Alice's client device can also store local information about the pending transfer. For example, Alice's client device may display (e.g., within the payment processing service's mobile application) a current remaining pre-loaded budget, which is reduced by an amount of the funds transfer to Bob when Alice's client device receives the acknowledgment from Bob's client device. At a second time, when Bob gains access to the network, Bob's client device sends the transfer verification information (e.g., along with Alice's account identifier) to the server system, which receives the transfer verification information. At this second time, Alice's client device need not be in an online state.

In some embodiments, the server system receives (1412), from the second client device, an account identifier of a user of the second client device. In some embodiments, the server system receives (1414), from the second client device, an indication of an amount of funds (e.g., that will be transferred between the first user's account and an account of the user of the second client device, herein called the second user's account). The proposed transfer amount is a maximum allowable transfer amount such that the amount of funds is less than or equal to the proposed transfer amount. Thus, in some embodiments, the server system allows the first user to transfer an amount up to, but not exceeding, her pre-loaded budget. To summarize, in accordance with a variety of embodiments, the server system receives some or all of the following information: the transfer verification information (which optionally includes a digital signature), an account identifier of the first user's account, and/or an account identifier of the second user's account, as well as optional additional information (e.g., timestamps and/or location stamps).

The server system determines (1418) a usage state of the transfer verification information. In some embodiments, the usage state is determined (1420) in accordance with a stored state identifier of the transfer verification information. For example, in some embodiments, the transfer verification information will include a digital signature that is both stored on the server system and sent to the first client device, and subsequently received from the second client device. In addition, the server system will store state information (e.g., a single bit), indicating whether the signature has been used (e.g., a 1 represents an unused signature and a 0 represents a used signature). As explained below, in this manner, the transfer verification information corresponds to a “disposable” or “single-use” transfer request, whereby once the transfer verification information has been used, additional funds transfers cannot be executed against the transfer verification information. Such embodiments provide a high degree of security in performing funds transfers.

Upon a determination that the usage state of the transfer verification information is an unused state, the server system transfers (1422) the amount of funds from an account of the user of the first client device to an account of a user of the second client device (e.g., using the first user's account identifier and the second user's account identifier).

Returning momentarily to operation 1402, in some embodiments, receiving the request from the first client device for transfer verification information includes (1424) receiving constraints corresponding to the proposed funds transfer. In some embodiments, the constraints include (1426) one or more of the following types of constraints: geographical constraints, temporal constraints, vendor constraints, and product category constraints. Examples of geographical constraints include a restriction that the transfer verification information be used (e.g., as indicated in the collection request) within particular towns, cities, zip codes, or within a predefined radius of a particular address. Examples of temporal constraints include that the transfer verification information be used (e.g., as indicated in the collection request) within a predefined period of time (e.g., within an hour, a day, or a week, and/or within a predefined time window such as 7:00 AM-10:00 AM on the 25 Oct., 2014). As used herein, the transfer verification information is considered used at the third time, when the first client device and second client device communicate to exchange the transfer verification information (e.g., the time the transaction between the first client device and the second client device is made). At the third time, the transfer verification information is optionally appended with a timestamp and/or a location stamp so that it can be made available to the server during the collection request. Examples of vendor constraints include that the transfer verification information be used (e.g., as indicated in the collection request) by specific vendors, e.g., by using their publicly available account identifiers. For example, Alice, knowing she may owe Bob money for movie tickets, will submit a transfer request prior to going to the movies listing Bob's email address (i.e., his account identifier in this example) as the only possible payee. Therefore, if the server system receives the transfer verification information from a different account (e.g., identified by a different account identifier), it can refuse the transfer. Examples of product category constraints including the transfer verification information be used to procure specific types of goods or services (e.g., movie tickets, books, or food).

Thus, in some embodiments, the server system determines whether the transfer verification information received from the second client device meets predefined criteria corresponding to the constraints. The operation of transferring the amount of funds from the account of the user of the first client device to the account of the user of the second client device is performed in accordance with both a determination that the second client device meets the predefined criteria corresponding to the constraints and the determination that the usage state is the unused state. For example, if a location stamp received by the server system from the second client device includes a time stamp that lies outside of a predefined time window, the server system will determine that the transfer verification information received from the second client device does not meet the predefine criteria and refuse the transfer of the amount of funds.

Upon a determination that the usage state of the transfer verification information is a used state, the server system refuses (1428) transfer of the amount of funds from an account of the user of the first client device to an account of a user of the second client device.

FIG. 15 is a diagram of a client-server environment 1500 in accordance with some implementations. The client-server environment 1500 includes a server system 1511, one or more mobile phone operators 1522 (e.g., mobile phone operator 1522-a and mobile phone operator 1522-b), one or more Internet service providers 1520 (e.g., Internet service provider 1520-a and Internet service provider 1522-b), and communications network 1504. Each of the server system 1511, the mobile phone operator 1522 (i.e. wireless carrier), and the Internet service providers 1520 are capable of being connected to the communication network 1504 in order to exchange information with one another and/or other devices and systems. Within the server system 1511, there is a server computer 1513 for receiving and processing data received from mobile client devices 1508 and personal/laptop computers 1510 (hereinafter “client device(s) 1508/1510”). For example, in some circumstances, server system 1511 receives requests from a first user's mobile client device 1508 for transfer verification information so that the first user of mobile client device 1508 may later transfer funds to a second user of another client device (e.g., laptop 1510-b).

Within the server system 1511, there is also a database 1512 for storing information (e.g., user account information corresponding to users of respective client devices 1508/1510, transfer verification information, signatures corresponding to said transfer verification information, and the like). Additionally, the mobile phone operator 1522 and the Internet service provider 1520 are operable to connect client devices 1508/1510 to the communication network 1504 as well. For example, a smart phone 1508 is operable with the network of the mobile phone operator 1522-a, which includes for example, a base station 1524-a. Similarly, for example, a first user's laptop computer 1510-a (or tablet, desktop, workstation or the like) is connectable to the network provided by a first Internet service provider 1520-a, which is ultimately connectable to the communication network 1504. A second user's laptop computer 1510-b (or tablet, desktop, workstation or the like) is connectable to the network provided by a second Internet service provider 1520-b, which is ultimately connectable to the communication network 1504.

When a respective client device 1508/1510 is connected to network 1504, and thereby connected to server system 1511, the respective client device 1508/1510 is said to be in an “online state.” Conversely, when a respective client device 1508/1510 is not connected to network 1504, and thereby not connected to server system 1511, the respective client device 1508/1510 is said to be in an “offline state.” The embodiments described herein can be used to securely transfer funds between an account of the first user and an account of the second user.

In some embodiments, client devices 1508/1510 are configured to communicate with one another using personal area networks 1580, for example, using Bluetooth and/or near field communication (NFC) based on RFID standards such as ISO/IEC 14443, ISO/IEC 18092, FeliCa and/or any standard defined by the NFC forum. In some embodiments, one of the client devices 1508/1510 (e.g., a payer client device) is a passive NFC “tag” that is powered by another client device 1508/1510. Communication over personal area networks 1580 is performed, in some circumstances, when one or both of the client devices 1508/1510 are in an offline state.

The communication network 1504 may be any combination of wired and wireless local area network (LAN) and/or wide area network (WAN), such as an intranet, an extranet, including a portion of the Internet. It is sufficient that the communication network 1504 provides communication capability between client devices and servers. In some implementations, the communication network 1504 uses the HyperText Transport Protocol (HTTP) to transport information using the Transmission Control Protocol/Internet Protocol (TCP/IP). HTTP permits a client device to access various resources available via the communication network 1504. However, the various implementations described herein are not limited to the use of any particular protocol.

Moreover, those skilled in the art will appreciate from the present application that any number of such devices and/or systems may be provided in a client-server environment, and particular devices may be altogether absent. In other words, the client-server environment 1500 is merely an example provided to discuss more pertinent features of the present application.

FIG. 16 is a diagram of an example implementation of a client device 1508/1510 for transferring funds (e.g., paying funds or collecting funds), in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, the device 1508/1510 includes one or more processing units (CPUs) 1604, one or more network or other communications interfaces 1608, a display 1601, memory 1606, near field communication hardware 1609, one or more mobile storage devices 1603, and one or more communication buses 1605 for interconnecting these and various other components. The communication buses 1605 may include circuitry (sometimes called a chipset) that interconnects and controls communications between system components. Memory 1606 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1606 may optionally include one or more storage devices remotely located from the CPU(s) 1604. Memory 1606, including the non-volatile and volatile memory device(s) within memory 1606, comprises a non-transitory computer readable storage medium.

In some implementations, memory 1606 or the non-transitory computer readable storage medium of memory 1606 stores the following programs, modules and data structures, or a subset thereof including an operating system 1616, a network communication module 1618, and a secure payment module 1620.

The operating system 1616 includes procedures for handling various basic system services and for performing hardware dependent tasks.

The network communication module 1618 facilitates communication with other devices via the one or more communication network interfaces 1608 (wired or wireless) and one or more communication networks, such as the Internet, other wide area networks, local area networks, metropolitan area networks, and so on.

In some implementations, secure payment module 1620 includes a server interaction sub-module 1622 for communicating with a server (e.g., server system 1511, FIG. 15). Such communications can include, for example, requests for transfer verification information (e.g., when client device 1508/1510 is acting as a payer), or transmissions of transfer verification information (e.g., when client device 1508/1510 is acting as a vendor, collector or payee). To this end, server interaction sub-module 1622 includes a set of instructions 1622-1 and, optionally, metadata 1622-2. In some implementations, secure payment module 1620 also includes a paying sub-module 1624 having a set of instructions 1624-1 and, optionally, metadata 1624-2, as well as a collecting sub-module 1626 having a set of instructions 1626-1 and, optionally, metadata 1626-2.

FIG. 17 is a block diagram illustrating a server system 1511, discussed above with reference to FIG. 15, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, server system 1511 includes one or more processing units (CPUs) 1702, one or more network or other communications interfaces 1708, memory 1706, and one or more communication buses 1704 for interconnecting these and various other components. The communication buses 1704 may include circuitry (sometimes called a chipset) that interconnects and controls communications between system components. Memory 1706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1706 may optionally include one or more storage devices remotely located from the CPU(s) 1702. Memory 1706, including the non-volatile and volatile memory device(s) within memory 1706, comprises a non-transitory computer readable storage medium.

In some implementations, memory 1706 or the non-transitory computer readable storage medium of memory 1706 stores the following programs, modules and data structures, or a subset thereof including an operating system 1716, a network communication module 1718, a secure payment handling module 1720.

The operating system 1716 includes procedures for handling various basic system services and for performing hardware dependent tasks.

The network communication module 1718 facilitates communication with other devices (e.g., client devices 1508/1510) via the one or more communication network interfaces 1708 (wired or wireless) and one or more communication networks, such as the Internet, other wide area networks, local area networks, metropolitan area networks, and so on.

The secure payment handling module 1720 is configured to receive a request from a first client device (e.g., client device 1508, FIG. 15) for transfer verification information corresponding to a proposed funds transfer. The received request includes a proposed amount of funds to be transferred in the proposed funds transfer. In some embodiments, the secure payment handling module 1722 generates the transfer verification information (e.g., including generating a digital signature) using a transfer verification information (TVI) sub-module, which includes a set of instructions 1722-1 and optional metadata 1722-2. In some embodiments, the secure payment handling module 1720 stores the generated transfer verification information in server data 1726 (e.g., embodied as database 1512, FIG. 15). The secure payment handling module 1720 sends the transfer verification information to the first client device and receives, from a second client device (e.g., laptop 1510-b, FIG. 15), the transfer verification information. The secure payment handling module determines a usage state of the transfer verification information (e.g., using verification sub-module 1724, which includes a set of instructions 1724-1 and optionally metadata 1724-2). In some embodiments, the verification sub-module 1724 performs other verification tasks as described with reference to method 1400 (FIGS. 14A-14B). When the usage state of the transfer verification information is an unused state, the secure payment handling module 1720 transfers an amount of funds from an account of the user of the first client device to an account of a user of the second client device. On the other hand, when the usage state of the transfer verification information is a used state, the secure payment handling module 1720 refuses transfer of the amount of funds from the account of the user of the first client device to the account of a user of the second client device.

A person of ordinary skill in the art can understand that all or a part of the steps of the methods according to the foregoing embodiments may be implemented by a program instructing relevant hardware. The program may be stored in a computer readable storage medium, and the storage medium may include a flash memory, a Read-Only Memory (ROM), a Random Access Memory (RAM), a magnetic disk, or an optical disc.

An electronic account data transfer method, and a related device and system disclosed in the embodiments of the present disclosure are described in detail. Specific examples are used for illustrating principles and implementation manners of the present disclosure. The above descriptions of the embodiments are merely provided for better understanding of the method and core ideas of the present disclosure. A person of ordinary skill in the art may make modifications to the specific implementation manner and the application scope according to the idea of the present disclosure. In conclusion, the content of the specification shall not be construed as a limitation to the present disclosure.

While particular embodiments are described above, it will be understood it is not intended to limit the claims that follow to these particular embodiments. On the contrary, the present disclosure includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the disclosure herein is for the purpose of describing particular embodiments only and is not intended to be limiting of the disclosure. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

What is claimed is:

1. A method, comprising,
at a server system having one or more processors, memory and one or more program modules stored in the memory and executed by the one or more processors:
receiving a request from a first client device for transfer verification information corresponding to a proposed funds transfer, the received request including a proposed amount of funds to be transferred in the proposed funds transfer;
sending the transfer verification information to the first client device;
receiving, from a second client device, the transfer verification information;
determining a usage state of the transfer verification information;
upon a determination that the usage state of the transfer verification information is an unused state, transferring an amount of funds from an account of the user of the first client device to an account of a user of the second client device; and
upon a determination that the usage state of the transfer verification information is a used state, refusing transfer of the amount of funds from the account of the user of the first client device to the account of a user of the second client device.

2. The method of claim 1, wherein the usage state is determined in accordance with a stored state identifier of the transfer verification information.

3. The method of claim 1, wherein the transfer verification information includes an account identifier of a user of the first client device.

4. The method of claim 1, further including, receiving, from the second client device, an account identifier of a user of the second client device.

5. The method of claim 1, further including, receiving, from the second client device, an indication of the amount of funds.

6. The method of claim 1, wherein the proposed transfer amount is a maximum allowable transfer amount such that the amount of funds is less than or equal to the proposed transfer amount.

7. The method of claim 1, wherein:
the transfer verification information is sent to the first client device at a first time wherein the first client device is in an online state at the first time; and
the server system is configured to receive the transfer verification information from the second client device at a second time, wherein the second client device is an online state at the second time.

8. The method of claim 1, wherein:
receiving the request from the first client device for transfer verification information includes receiving constraints corresponding to the proposed funds transfer; and
the method further includes:
determining whether the transfer verification information received from the second client device meets predefined criteria corresponding to the constraints;
wherein the operation of transferring the amount of funds from the account of the user of the first client device to the account of the user of the second client device is performed in accordance with both a determination that the second client device meets the predefined criteria corresponding to the constraints and the determination that the usage state is the unused state.

9. The method of claim 8, wherein the constraints include one or more of the following types of constraints: geographical constraints, temporal constraints, vendor constraints, and product category constraints.

10. A server system, comprising:
one or more processors;
memory; and
one or more programs, wherein the one or more programs are stored in the memory and configured to be executed by the one or more processors, the one or more programs including instructions that when executed by the one or more processors cause the server system to:
receive a request from a first client device for transfer verification information corresponding to a proposed funds transfer, the received request including a proposed amount of funds to be transferred in the proposed funds transfer;
send the transfer verification information to the first client device;
receive, from a second client device, the transfer verification information;
determine a usage state of the transfer verification information;
upon a determination that the usage state of the transfer verification information is an unused state, transfer an amount of funds from an account of the user of the first client device to an account of a user of the second client device; and
upon a determination that the usage state of the transfer verification information is a used state, refuse transfer of the amount of funds from the account of the user of the first client device to the account of a user of the second client device.

11. The server system of claim 10, wherein the usage state is determined in accordance with a stored state identifier of the transfer verification information.

12. The server system of claim 10, wherein the transfer verification information includes an account identifier of a user of the first client device.

13. The server system of claim 10, the one or more programs further including instructions that cause the server system to receive, from the second client device, an account identifier of a user of the second client device.

14. The server system of claim 10, the one or more programs further including instructions that cause the server system to receive, from the second client device, an indication of the amount of funds.

15. The server system of claim 10, wherein the proposed transfer amount is a maximum allowable transfer amount such that the amount of funds is less than or equal to the proposed transfer amount.

16. The server system of claim 10, wherein:
the transfer verification information is sent to the first client device at a first time wherein the first client device is in an online state at the first time; and
the server system is configured to receive the transfer verification information from the second client device at a second time, wherein the second client device is an online state at the second time.

17. The server system of claim 10, wherein:
receiving the request from the first client device for transfer verification information includes receiving constraints corresponding to the proposed funds transfer; and
the one or more programs further include instructions that cause the server system to:
determine whether the transfer verification information received from the second client device meets predefined criteria corresponding to the constraints;
wherein the operation of transferring the amount of funds from the account of the user of the first client device to the account of the user of the second client device is performed in accordance with both a determination that the second client device meets the predefined criteria corresponding to the constraints and the determination that the usage state is the unused state.

18. The server system of claim 16, wherein the constraints include one or more of the following types of constraints: geographical constraints, temporal constraints, vendor constraints, and product category constraints.

19. A non-transitory computer readable storage medium storing one or more programs, the one or more programs comprising instructions, which when executed by a server system with one or more processors and memory, cause the server system to:
receive a request from a first client device for transfer verification information corresponding to a proposed funds transfer, the received request including a proposed amount of funds to be transferred in the proposed funds transfer;
send the transfer verification information to the first client device;
receive, from a second client device, the transfer verification information;
determine a usage state of the transfer verification information;
upon a determination that the usage state of the transfer verification information is an unused state, transfer an amount of funds from an account of the user of the first client device to an account of a user of the second client device; and
upon a determination that the usage state of the transfer verification information is a used state, refuse transfer of the amount of funds from the account of the user of the first client device to the account of a user of the second client device.

20. The non-transitory computer readable storage medium of claim 19, wherein the usage state is determined in accordance with a stored state identifier of the transfer verification information.
